(19) United States
(12) Patent Application Publication
(10) Pub. No.: US 2025/0312938 A1
(43) Pub. Date: Oct. 9, 2025

(54) STRUCTURES WITH CIRCUMFERENTIALLY-EXTENDING DENSIFIED FIBROUS PLANT MATERIALS, AND SYSTEMS AND METHODS FOR FABRICATION AND USE THEREOF

(71) Applicant: UNIVERSITY OF MARYLAND, COLLEGE PARK, College Park, MD (US)

(72) Inventors: Liangbing HU, Woodbridge, CT (US); Yu LIU, Berwyn Heights, MD (US); Teng LI, Potomac, MD (US); Qiongyu CHEN, Beltsville, MD (US)

(21) Appl. No.: 18/865,989

(22) PCT Filed: May 16, 2023
(86) PCT No.: PCT/US2023/022351

§ 371 Date: Nov. 14, 2024

Related U.S. Application Data
(60) Provisional application No. 63/364,794, filed on May 16, 2022.

(51) Int. Cl. B27H 1/00; B27D 3/00; B27H 5/00; B27L 5/00

(52) U.S. Cl. CPC B27H 1/00; B27D 3/00; B27L 5/00; B27H 5/00

(57) ABSTRACT

A structure can be formed by wrapping one or more densified, lignin-compromised wood veneers wrapped around a central axis. The wrapped wood veneers can form a circumferentially-extending wood wall. A glue can be provided on one or more surface portions of each wood veneer. The wood veneers can be lignin-compromised by in situ lignin modification, partial delignification, or full delignification. The circumferentially-extending wood wall can form a hollow member, for example, a tube, pipe, cup, tank, or bottle. Alternatively, the circumferentially-extending wood wall can surround a central member, for example, to form a rod, bat, club, or dowel.

### CROSS-REFERENCE TO RELATED APPLICATION

The present application claims the benefit of U.S. Provisional Application No. 63/364,794, filed May 16, 2022, entitled “Densified Wood-Based Hollow Structures and the Manufacture and Use Thereof,” which hereby is incorporated by reference herein in its entirety.

### STATEMENT REGARDING FEDERALLY SPONSORED RESEARCH

This invention was made with government support under DEAR0001025 awarded by the U.S. Department of Energy, Advanced Research Projects Agency-Energy (DOE-ARPA-E), and under HR00112320009 awarded by the Defense Advanced Research Projects Agency (DARPA). The government has certain rights in the invention.

### FIELD

The present disclosure relates generally to the processing of fibrous plant materials, and more particularly, to structures formed by wrapping densified, lignin-compromised fibrous plant materials, for example, wood or bamboo veneers.

### BACKGROUND

In structural applications requiring hollow members, metals (e.g., aluminum) have typically been used, due to their relatively strong mechanical properties as well as existing manufacturing capabilities to form such metals into a variety of sizes and shapes (e.g., via casting). For example, aluminum tubes have been used in the manufacture and construction of buildings (e.g., for façade design, curtain walls, and/or window frames). Other applications for hollow members, for example, for fluid conveyance, typically employ plastic and concrete, as well as metals. However, the manufacture of metal, concrete, and plastic components can produce greenhouse gas emissions, and plastic waste can be a significant source of pollution. While wood has been considered a more sustainable alternative to metal, concrete, and plastic, conventional wood-based hollow structures generally have insufficient mechanical properties for such applications.

Embodiments of the disclosed subject matter may address one or more of the above-noted problems and disadvantages, among other things.

### SUMMARY

Embodiments of the disclosed subject matter provide structures with one or more densified, lignin-compromised fibrous plant material veneers forming a circumferentially-extending wall. In some embodiments, the one or more fibrous plant material veneers are subjected to in situ lignin modification or delignification (e.g., partial or full), densified by pressing in a direction crossing a longitudinal growth direction of the fibrous plant material, and then wrapped or molded around a central axis to form the circumferentially-extending wall. In some embodiments, the circumferentially-extending wall forms a hollow structure, such as a tube or pipe. Alternatively, in some embodiments, the circumferentially-extending wall forms part of a solid structure, such as a dowel or rod, for example.

By using veneers wrapped around a central mold axis at specific angles, the dimensional limits of the source fibrous plant material (e.g., the size of the tree trunk or bamboo stalk) can be overcome, thereby allowing structures of any desired size (e.g., length, diameter, wall thickness, etc.) and shape (e.g., circular, triangular, rectangular, etc.) to be achieved. Moreover, by appropriate selection of the number of veneer layers forming the fibrous plant material wall, the thickness of the veneer layers and/or the wall, the diameter of the structure, and/or the orientation of the cellulose fibers within the veneer layers, the mechanical properties of the resulting structure can be tailored to a desired application. For example, in some embodiments, wood tubes with enhanced energy absorption properties can be fabricated to exploit the weak direction of the wood by exhibiting a unique petal-like failure behavior.

In one or more embodiments, a structure can comprise one or more densified, lignin-compromised fibrous plant material veneers wrapped around a central axis, so as to form a circumferentially-extending wall.

In one or more embodiments, an energy absorbing system can comprise a plurality of structures. Each structure can comprise one or more densified, lignin-compromised fibrous plant material veneers wrapped around a central axis, so as to form a circumferentially-extending wall.

In one or more embodiments, a method can comprise subjecting one or more natural fibrous plant material veneers to one or more chemical treatments, so as to form one or more lignin-compromised veneers. In some embodiments, the one or more chemical treatments can in situ modify the lignin in the veneers, can partially delignify the veneers, or fully delignify the veneers. The method can further comprise compressing the one or more lignin-compromised veneers along a direction crossing a longitudinal growth direction of the fibrous plant material, so as to form one or more densified, lignin-compromised veneers. The method can also comprise wrapping the one or more densified, lignin-compromised veneers around a central axis, so as to form a circumferentially-extending wall.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated to assist in the illustration and description of underlying features. Throughout the figures, like reference numerals denote like elements.

FIG. 1A illustrates radial, longitudinal, and rotary cut pieces of natural wood, as well as a cross-section in the radial-tangential plane of natural wood, according to one or more embodiments of the disclosed subject matter.

FIG. 1B is a simplified schematic diagram of partial delignification and densification of a wood veneer, according to one or more embodiments of the disclosed subject matter.

FIG. 1C shows macroscale and microscale images of natural wood veneer and densified, partially-delignified wood veneer.

FIG. 1D is a simplified schematic diagram of lignin modification and densification of a wood veneer, according to one or more embodiments of the disclosed subject matter.

FIG. 1E is a simplified schematic diagram illustrating continuous cutting of a veneer from a wood trunk, according to one or more embodiments of the disclosed subject matter;

FIG. 1F is a simplified schematic diagram illustrating a fabrication setup for forming densified, lignin-compromised wood veneers, according to one or more embodiments of the disclosed subject matter.

FIG. 1G illustrates a simplified partial cut-away view of a natural bamboo segment with a rotary cut piece, according to one or more embodiments of the disclosed subject matter.

FIG. 1H shows a magnified image (top) of the culm of the natural bamboo segment of FIG. 1G and a further magnified image (bottom) showing the hierarchical microstructure of the culm wall.

FIG. 2A is a simplified schematic diagram illustrating wrapping of a densified, lignin-compromised wood veneer, with cellulose fibers parallel to a central mold axis, to form a circumferentially-extending wood wall, according to one or more embodiments of the disclosed subject matter.

FIG. 2B is a simplified schematic diagram illustrating a fabrication setup for simultaneous wrapping of multiple densified, lignin-compromised wood veneers, with cellulose fibers parallel to a central mold axis, to form a multi-layer circumferentially-extending wood wall, according to one or more embodiments of the disclosed subject matter.

FIG. 2C is a simplified schematic diagram illustrating a fabrication process employing a cylindrical mold for wrapping of multiple densified, lignin-compromised wood veneers to form a multi-layer circumferentially-extending wood wall, according to one or more embodiments of the disclosed subject matter.

FIG. 2D illustrates wrapping of multiple densified, lignin-compromised wood veneers, with cellulose fibers parallel to a central mold axis, to form a cylindrical tube, according to one or more embodiments of the disclosed subject matter.

FIG. 2E shows macroscale and microscale images of a cylindrical tube fabricated based on the wrapping orientation of FIG. 2D, according to one or more embodiments of the disclosed subject matter.

FIG. 2F shows an image of cellulose fibers within the cylindrical tube of FIG. 2E.

FIG. 3A is a simplified schematic diagram illustrating wrapping of a densified, lignin-compromised wood veneer, with cellulose fibers at an angle with respect to the central mold axis, to form a circumferentially-extending wood wall, according to one or more embodiments of the disclosed subject matter.

FIG. 3B is a simplified schematic diagram illustrating a fabrication setup for simultaneous wrapping of multiple densified, lignin-compromised wood veneers, with cellulose fibers at an angle with respect to the central mold axis, to form a multi-layer circumferentially-extending wood wall, according to one or more embodiments of the disclosed subject matter.

FIG. 3C is a simplified schematic diagram illustrating wrapping of another densified, lignin-compromised wood veneer, with cellulose fibers at another angle with respect to the central mold axis, to form a multi-layer circumferentially-extending wood wall, according to one or more embodiments of the disclosed subject matter.

FIG. 4A illustrates wrapping of multiple densified, lignin-compromised wood veneers, with cellulose fibers at about a 45° angle with respect to the central mold axis, to form a cylindrical tube, according to one or more embodiments of the disclosed subject matter.

FIG. 4B shows macroscale and microscale images of a cylindrical tube fabricated based on the wrapping orientation of FIG. 4A, according to one or more embodiments of the disclosed subject matter.

FIG. 4C shows an image of cellulose fibers in the different veneer layers of the cylindrical tube of FIG. 4B.

FIG. 4D illustrates wrapping of multiple densified, lignin-compromised wood veneers, with cellulose fibers at crossing 45° angles with respect to the central mold axis, to form a cylindrical tube, according to one or more embodiments of the disclosed subject matter.

FIG. 4E shows macroscale and microscale images of a cylindrical tube fabricated based on the wrapping orientation of FIG. 4D, according to one or more embodiments of the disclosed subject matter.

FIG. 4F shows an image of cellulose fibers in the different veneer layers of the cylindrical tube of FIG. 4E.

FIG. 5 is a simplified schematic diagram illustrating wrapping of a densified, lignin-compromised wood veneer, with cellulose fibers substantially perpendicular to a plane containing the central mold axis, to form a circumferentially-extending wood wall, according to one or more embodiments of the disclosed subject matter.

FIG. 6A shows a simplified cross-sectional view of a hollow tube formed by wrapping a single densified, lignin-compromised fibrous plant material veneer, according to one or more embodiments of the disclosed subject matter.

FIG. 6B shows a simplified cross-sectional view of another hollow tube formed by wrapping a single densified, lignin-compromised fibrous plant material veneer, according to one or more embodiments of the disclosed subject matter.

FIG. 6C shows a simplified cross-sectional view of a hollow tube formed by wrapping multiple densified, lignin-compromised fibrous plant material veneers, according to one or more embodiments of the disclosed subject matter.

FIG. 6D shows a simplified cross-sectional view of a composite pipe formed by wrapping one or more densified, lignin-compromised fibrous plant material veneers, according to one or more embodiments of the disclosed subject matter.

FIG. 6E are images of exemplary tube cross-sections that can be formed by wrapping densified, lignin-compromised wood veneers, according to one or more embodiments of the disclosed subject matter.

FIG. 7A illustrates an energy absorbing configuration for a circumferentially-extending wood wall formed by one or more densified, lignin-compromised wood veneers wrapped around a central axis, according to one or more embodiments of the disclosed subject matter.

FIG. 7B shows exemplary energy absorbing behavior when a circumferentially-extending wood wall is subjected to an axial compression load, according to one or more embodiments of the disclosed subject matter.

FIG. 7C shows a petaling failure mode at an axial end of the circumferentially-extending wood wall of FIG. 7B.

FIG. 8A is a simplified cross-sectional view of an axial-loading configuration for use of the circumferentially-extending wall, according to one or more embodiments of the disclosed subject matter.

FIGS. 8B-8C show energy-absorbing systems that employ multiple circumferentially-extending walls, according to one or more embodiments of the disclosed subject matter.

FIGS. 9A-9B are simplified cross-sectional views of closed-end hollow structures formed by circumferentially-extending walls, according to one or more embodiments of the disclosed subject matter.

FIGS. 9C-9D are simplified cross-sectional views of solid structures formed by circumferentially-extending walls surrounding a central member, according to one or more embodiments of the disclosed subject matter.

FIGS. 9E-9F are images of a solid rod and a solid bat, respectively, fabricated by wrapping multiple densified, lignin-compromised wood veneers about a natural wood core, according to one or more embodiments of the disclosed subject matter.

FIG. 10A is a simplified process flow diagram illustrating a method for forming densified, lignin-compromised fibrous plant material veneers, according to one or more embodiments of the disclosed subject matter.

FIG. 10B is a simplified process flow diagram illustrating a method for wrapping one or more densified, lignin-compromised fibrous plant material veneers to form a circumferentially-extending wall, according to one or more embodiments of the disclosed subject matter.

FIG. 11 is a graph of compressive strength of cylindrical tubes formed by wrapping densified, partially-delignified wood veneers for different fabrication and tube parameters.

FIGS. 12A-12B are graphs comparing force-displacement curves and energy absorption, respectively, for a cylindrical tube formed of densified, partially-delignified wood veneers with wood fibers parallel to the central mold axis (flat wrap), a cylindrical tube formed of aluminum, and a cylindrical tube formed of carbon fiber cloth.

FIG. 13A is a graph of gas pressure versus time for a cylindrical tube formed of densified, partially-delignified wood veneers, for determining gas permeability of the cylindrical tube.

FIG. 13B is a graph comparing flexural strength for cylindrical pipes formed of concrete and a cylindrical pipe formed of densified, partially-delignified wood veneers with wood fibers parallel to the central mold axis (flat wrap).

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about” is recited. Whenever “substantially.” “approximately.” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower.” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including.” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following are provided to facilitate the description of various aspects of the disclosed subject matter and to guide those skilled in the art in the practice of the disclosed subject matter.

Fibrous plant material: A portion (e.g., a cut portion, via mechanical means or otherwise) of any photosynthetic eukaryote of the kingdom Plantae in its native state as grown. In some embodiments, the fibrous plant material comprises wood (e.g., hardwood or softwood), bamboo (e.g., any of Bambusoideae, such as but not limited to Moso, Phyllostachys vivax, Phyllostachys viridis, Phyllostachys bambusoides, and Phyllostachys nigra), reed (e.g., any of common reed (Phragmites australis), giant reed (Arundo donax), Burma reed (Neyraudia reynaudiana), reed canary-grass (Phalaris arundinacea), reed sweet-grass (Glyceria maxima), small-reed (Calamagrostis species), paper reed (Cyperus papyrus), bur-reed (Sparganium species), reed-mace (Typha species), cape thatching reed (Elegia tectorum), thatching reed (Thamnochortus insignis), or grass (e.g., a species selected from the Poales order or the Poaceae family). Alternatively or additionally, in some embodiments, the plant material can be any type of fibrous plant composed of lignin, hemicellulose, and cellulose. For example, the plant material can be bagasse (e.g., formed from processed remains of sugarcane or sorghum stalks) or straw (e.g., formed from processed remains of cereal plants, such as rice, wheat, millet, or maize).

Wood: The body of a naturally-occurring tree that comprises cellulose fibers embedded in a matrix of lignin and hemicellulose. In some embodiments, the wood can be a hardwood (e.g., having a native lignin content in a range of 18-25 wt %) or a softwood (e.g., having a native lignin content in a range of 25-35 wt %), such as, but not limited to, basswood, oak, poplar, ash, alder, aspen, balsa wood, beech, birch, cherry, butternut, chestnut, cocobolo, elm, hickory, maple, oak, padauk, plum, walnut, willow, yellow poplar, bald cypress, cedar, cypress, douglas fir, fir, hemlock, larch, pine, redwood, spruce, tamarack, juniper, and yew.

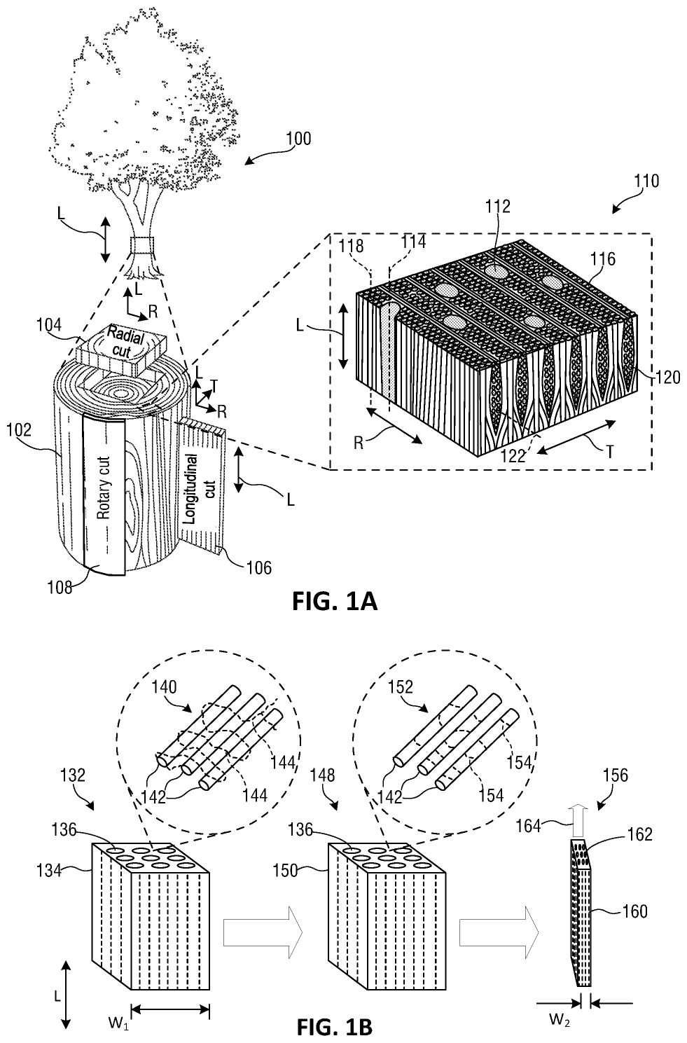

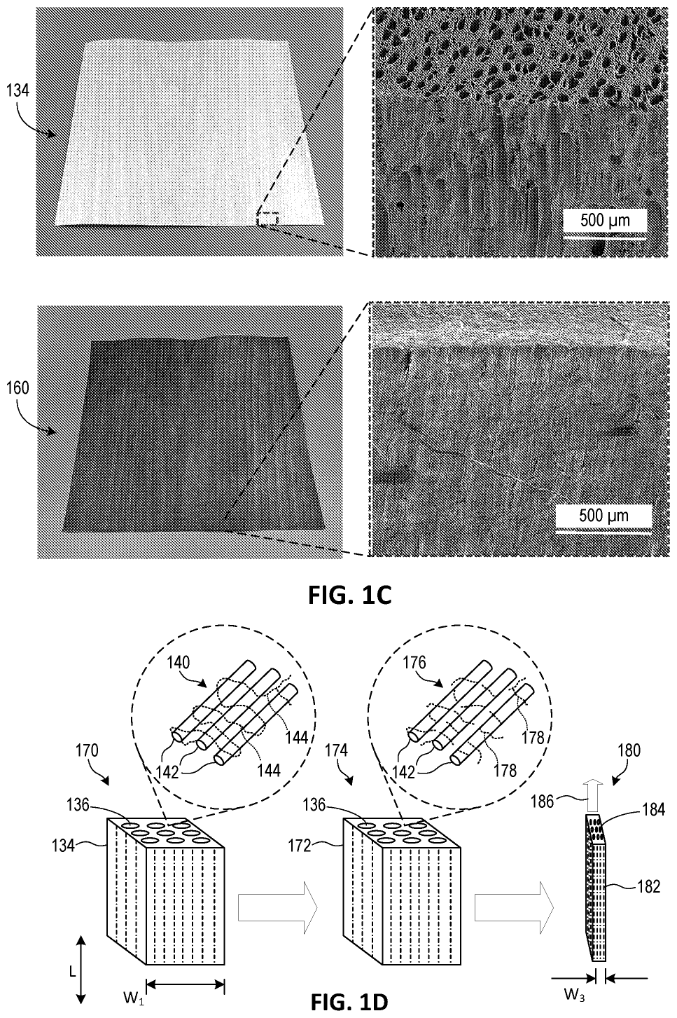

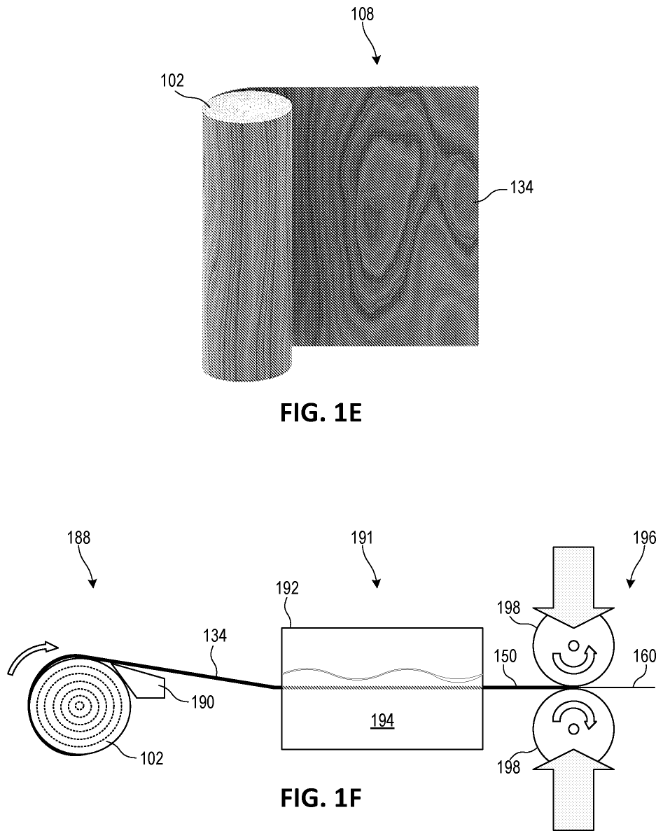

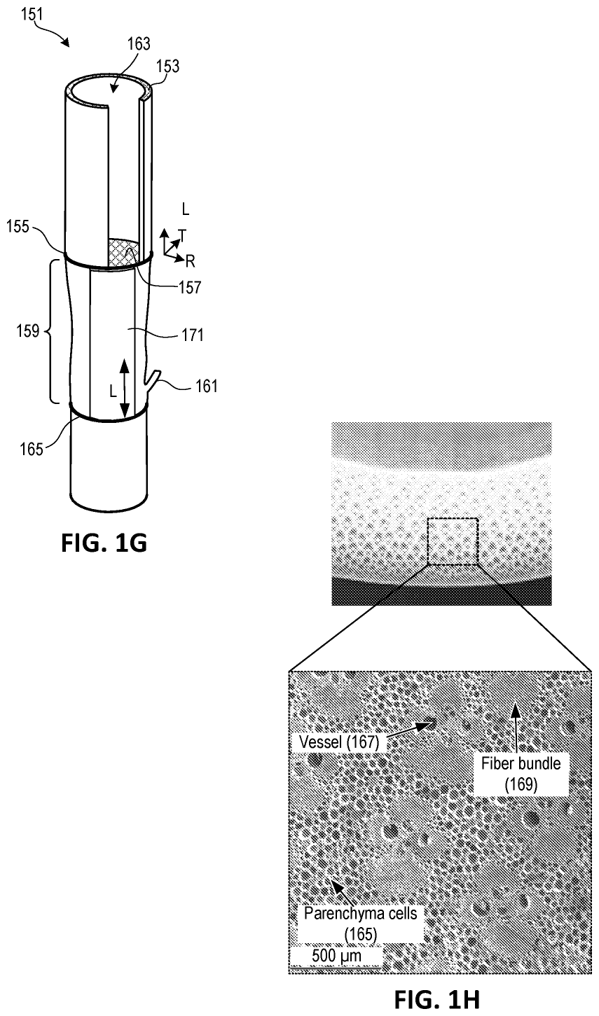

Longitudinal growth direction (L): A direction along which the fibrous plant material grows from its roots or from a main body thereof (e.g., direction L for trunk 102 from tree 100 in FIG. 1A). Cellulose nanofibers forming cell walls of fiber cells, vessels, and/or tracheids of the fibrous plant material may generally be aligned with the longitudinal direction. In some cases, the longitudinal direction for the fibrous plant material may be generally vertical and/or correspond to a direction of the plant's water transpiration stream (e.g., from roots of the tree). The longitudinal direction can be substantially perpendicular to the radial and tangential directions of the fibrous plant material.

Radial growth direction (R): A direction that extends from a center portion of the fibrous plant material outward (e.g., direction R for trunk 102 from tree 100 in FIG. 1A). In some embodiments, ray cells of the fibrous plant material (e.g., ray cells 120 for microstructure 110 in FIG. 1A) can extend along the radial direction. In some cases, the radial direction for the fibrous plant material may be generally horizontal. The radial direction can be substantially perpendicular to the longitudinal and tangential directions of the fibrous plant material.

Tangential growth direction (T): A direction substantially perpendicular to both the longitudinal and radial directions in a particular cut of the fibrous plant material (e.g., direction T for trunk 102 from tree 100 in FIG. 1A). In some cases, the tangential direction for the fibrous plant material may be generally horizontal. In some embodiments, the tangential direction can follow a growth ring of the fibrous plant material (e.g., along a circumferential direction of the trunk 102).

Veneer: A continuous piece of fibrous plant material cut along the tangential growth direction (e.g., from a tree trunk or bamboo segment), and having a thickness less than or equal to 3 mm. In some embodiments, dimensions of the continuous piece of fibrous plant material in a plane perpendicular to the thickness can be much larger than the thickness, for example, at least an order of magnitude larger. In some embodiments, the thickness of the veneer can be less than or equal to 300 μm, for example, in a range of 100-250 μm, inclusive. In some embodiments, the veneer can be cut from the fibrous plant material using a rotary cutting technique (e.g., to yield the rotary cut piece 108 in FIG. 1A).

Lignin-compromised fibrous plant material: Fibrous plant material that has been modified by one or more chemical treatments to in situ modify the native lignin therein, partially remove the native lignin therein (i.e., partial delignification), or fully remove the native lignin therein (i.e., full delignification). In some embodiments, the lignin-compromised fibrous plant material can substantially retain the native microstructure of the natural fibrous plant material formed by cellulose-based cell walls.

Partial Delignification: The removal of some (e.g., at least 1%) but not all (e.g., less than or equal 90%) of native lignin from the naturally-occurring fibrous plant material. In some embodiments, the partial delignification can be performed by subjecting the natural fibrous plant material to one or more chemical treatments. Lignin content within the fibrous plant material before and after the partial delignification can be assessed using known techniques in the art, for example, Laboratory Analytical Procedure (LAP) TP-510-42618 for “Determination of Structural Carbohydrates and Lignin in Biomass,” Version Aug. 3, 2012, published by National Renewable Energy Laboratory (NREL), and ASTM E1758-01 (2020) for “Standard Test Method for Determination of Carbohydrates in Biomass by High Performance Liquid Chromatography.” published by ASTM International, both of which are incorporated herein by reference. In some embodiments, the partial delignification process can be, for example, as described in U.S. Publication No. 2020/0223091, published Jul. 16, 2020 and entitled “Strong and Tough Structural Wood Materials, and Methods for Fabricating and Use Thereof,” which delignification processes are incorporated herein by reference.

Full Delignification: The removal of substantially all (e.g., 90-100%) of native lignin from the naturally-occurring fibrous plant material. In some embodiments, the full delignification can be performed by subjecting the natural fibrous plant material to one or more chemical treatments. Lignin content within the fibrous plant material before and after the full delignification can be assessed using the same or similar techniques as those noted above for partial delignification. In some embodiments, the full delignification process can be, for example, as described in U.S. Publication No. 20200238565, published Jul. 30, 2020 and entitled “Delignified Wood Materials, and Methods for Fabricating and Use Thereof,” which delignification processes are incorporated herein by reference.

In situ lignin modification: Altering one or more properties of native lignin in the naturally-occurring fibrous plant material, without removing the altered lignin in the fibrous plant material. In some embodiments, the lignin content of the fibrous plant material prior to and after the in situ modification can be substantially the same, for example, such that the in situ modified fibrous plant material retains at least 95% (e.g., removing no more than 1%, or no more than 0.5%, of the native lignin content) of the native lignin content. In some embodiments, the fibrous plant material can be in situ modified (e.g., by chemical reaction with OH⁻) to depolymerize lignin, with the depolymerized lignin being retained within the fibrous plant material microstructure. The lignin content within the fibrous plant material before and after lignin modification can be assessed using known techniques in the art, for example, Laboratory Analytical Procedure (LAP) TP-510-42618 for “Determination of Structural Carbohydrates and Lignin in Biomass,” Version Aug. 3, 2012, published by National Renewable Energy Laboratory (NREL), ASTM E1758-01 (2020) for “Standard Test Method for Determination of Carbohydrates in Biomass by High Performance Liquid Chromatography,” published by ASTM International, and/or Technical Association of Pulp and Paper Industry (TAPPI), Standard T 222-om-83, “Standard Test Method for Acid-Insoluble Lignin in Wood,” all of which are incorporated herein by reference. In some embodiments, the lignin modification process can be, for example, as described in International Publication No. WO 2023/028356, published Mar. 2, 2023 and entitled “Waste-free Processing for Lignin Modification of Fibrous Plant Materials, and Lignin-modified Fibrous Plant Materials,” which lignin modification processes are incorporated herein by reference.

Moisture content: The amount of fluid, typically water, retained within the microstructure of the fibrous plant material. In some embodiments, the moisture content (MC) can be determined by oven-dry testing, for example by calculating the change in weight achieved by oven drying (e.g., at 103° C. for 6 hours) the plant material, using the equation:

$$MC ( \% ) = \frac{weight before dry - weight after dry}{weight before dry} \times 100.$$

Alternatively or additionally, moisture content can be assessed using known techniques in the art, for example, an electrical moisture meter or other techniques disclosed in ASTM D4442-20 (2020) for “Standard Test Methods for Direct Moisture Content Measurement of Wood and Wood-based Materials,” published by ASTM International, which standard is incorporated herein by reference.

Densified fibrous plant material: Fibrous plant material that has been subjected to pressing such that lumina formed by cellulose-based cells in the native microstructure substantially collapse, and such that the density of the densified fibrous plant material is greater than that of the natural fibrous plant material prior to densifying. In some embodiments, densification of lignin-compromised fibrous plant material can yield a density of at least 1 g/cm³, for example, in a range of 1.15-1.5 g/cm³ (e.g., about 1.3 g/cm³). In some embodiments, densification of a lignin-compromised fibrous plant material veneer can reduce a thickness of the veneer, for example, by at least a factor of 2. For example, the densification can reduce the veneer thickness from a first value in a range of 0.02-1.5 mm to a second value less than or equal to 300 μm. In some embodiments, the densification process can be, for example, as described in U.S. Publication No. 2020/0223091, published Jul. 16, 2020 and entitled “Strong and Tough Structural Wood Materials, and Methods for Fabricating and Use Thereof,” and/or International Publication No. WO 2023/028356, published Mar. 2, 2023 and entitled “Waste-free Processing for Lignin Modification of Fibrous Plant Materials, and Lignin-modified Fibrous Plant Materials,” which densification processes are incorporated herein by reference.

### INTRODUCTION

Disclosed herein are hollow or solid structures formed by wrapping or molding one or more fibrous plant material veneer layers about an axis (e.g., a common central axis), thereby forming a circumferentially-extending wall. At least one of the fibrous plant material veneer layers can be a densified, lignin-compromised fibrous plant material veneer. To create the fibrous plant material veneer layer, natural fibrous plant material can be cut into a natural fibrous plant material veneer, for example, via rotary cutting. The lignin therein can then be compromised via one or more chemical treatments to soften the fibrous plant material veneer. The softened fibrous plant material veneer can be mechanically pressed to yield a densified, lignin-compromised fibrous plant material veneer. The thickness of the densified veneer can be sufficiently small (e.g., <1 mm) that the veneer can be readily bent and molded without breaking. In some embodiments, at least part of the surface of the densified, lignin-compromised fibrous plant material veneer can be coated with a glue (e.g., a substantially even coating over its surface) and then molded along (e.g., flat molding) or at a certain angle (e.g., helix or crossing helix) with respect to the cellulose fiber direction within the fibrous plant material veneer. A wall thickness of the molded structure can be selected by changing the number of fibrous plant material veneer layers (e.g., molded simultaneously together or sequentially). In some embodiments, the structure formed by the circumferentially-extending fibrous plant material wall can exhibit sufficiently high mechanical strength (e.g., a compressive strength of 50-90 MPa, which is higher than comparable aluminum alloy tubes) for use in structural applications. Alternatively or additionally, the structure formed by the circumferentially-extending fibrous plant material wall can exhibit enhanced energy absorption. In some embodiments, the circumferentially-extending fibrous plant material wall forms a hollow structure, such as a tube or pipe. Alternatively, in some embodiments, the circumferentially-extending fibrous plant material wall forms part of a solid structure, such as dowel or rod, for example.

### Densified, Lignin-Compromised Veneers

Natural wood has a unique three-dimensional porous microstructure comprising and/or defined by various interconnected cells. For example, FIG. 1A illustrates a hardwood microstructure 110 where vessels 112 are disposed within a hexagonal array of wood fiber cells 116 in a longitudinally-extending cell region. The vessels and fiber cells can extend along longitudinal direction, L, of the wood. Thus, the lumen of each vessel 112 can have an extension axis 114 that is substantially parallel to the longitudinal direction, L, and the lumen of each fiber cell 116 can have an extension axis 118 that is substantially parallel to the longitudinal direction. L. Arranged between adjacent regions along tangential direction, T, is a radially-extending cell region, where a plurality of ray cells 120 are disposed. The ray cells 120 can extend along radial direction, R, of the wood. Thus, the lumen of each ray cell 120 can have an extension axis 122 that is substantially parallel to the radial direction, R, of the wood. An intracellular lamella is disposed between the vessels 112, fiber cells 116, and ray cells 120, and serves to interconnect the cells together. Softwoods can have a similar microstructure structure as that of hardwood, but with the vessels and wood fibers being replaced by tracheids that extend in the longitudinal direction, L, of the wood.

The cut direction of the original piece of wood can dictate the orientation of the cell lumina in the final structure. For example, in some embodiments, a piece of natural wood can be cut from a trunk 102 of tree 100 in a vertical or longitudinal direction (e.g., parallel to longitudinal wood growth direction, L) such that lumina of longitudinally-extending cells are oriented substantially parallel to a major face (e.g., largest surface area) of the longitudinal-cut wood piece 106. In the longitudinal-cut wood piece 106, the tangential direction, T, can be substantially perpendicular to the major face. Alternatively, in some embodiments, the piece of natural wood can be cut in a horizontal or radial direction (e.g., perpendicular to longitudinal wood growth direction, L) such that lumina of longitudinally-extending cells are oriented substantially perpendicular to the major face of the radial-cut wood piece 104. Alternatively, in some embodiments, the piece of natural wood can be cut in a rotation direction (e.g., perpendicular to the longitudinal wood growth direction L and along a circumferential direction of the trunk 102) such that lumina of longitudinal cells are oriented substantially parallel to the major face of the rotary-cut wood piece 108. In some embodiments, the piece of natural wood can be cut at any other orientation between longitudinal, radial, and rotary cuts. In some embodiments, the cut orientation of the wood piece may dictate certain mechanical properties of the final processed wood.

FIG. 1B illustrates aspects for delignification and densification of a wood veneer 134 for use in forming a circumferentially-extending wood wall. At initial stage 132 prior to delignification, the wood veneer 134 can have open lumina 136 formed by cellulose-based cell walls in the native microstructure of the wood. For example, the microstructure can have longitudinally-extending fiber cell walls formed of a composite 140 of cellulose fibrils 142 bonded together by hemicellulose and lignin adhesive matrix 144, which is strong and rigid. By immersing the wood veneer 134 in one or more chemical solutions, the lignin in matrix 144 can be dissolved and removed from the veneer by subsequent washing. For example, the chemical solutions can include any of NaOH (LiOH or KOH), NaOH+Na₂SO₃/Na₂SO₄, NaOH+Na₂S, NaHSO₃+SO₂+H₂O, NaHSO₃+Na₂SO₃, NaOH+Na₂SO₃, NaOH/NaH₂O₃+AQ, NaOH/Na₂S+AQ, NaOH+Na₂SO₃+AQ, Na₂SO₃+NaOH+CH₃OH+AQ, NaHSO₃+SO₂+AQ, NaOH+Na₂Sx, where AQ is Anthraquinone.

At a subsequent stage 148 after delignification, lignin-compromised wood veneer 150 can have a microstructure 152 that retains the arrangement of cellulose fibrils 142 (as well as the open lumina 136) but has a reduced content of lignin. In some embodiments, the microstructure 152 of the wood veneer 150 can retain at least some lignin 154. However, the lignin-compromised wood veneer 150 is significantly softer than the wood veneer 134 in its native state, thereby allowing the veneer 150 to be compressed to form a highly-densified veneer 160 at final stage 156, with the previously-open cellulose-based lumina 136 now substantially collapsed as shown at 162 in FIGS. 1B and 1n the images of FIG. 1C. In some embodiments, the pressing for densification may be along a direction substantially perpendicular to, or at least crossing, a longitudinal growth direction (L) of the wood veneer.

In some embodiments, a width, W₁, of the native wood veneer 134 can be at least 2 times (e.g., at least 3-5 times) a width, W₂, of the densified, lignin-compromised wood veneer 160. In some embodiments, the thickness W₂ may be reduced by greater than 60%, 70%, or 80%, as compared to W₁ of the veneer 134, and/or the pressing can result in a compression ratio (W₁:W₂) of 1.1:1 to 10:1. For example, W₁ can be less than or equal to 5 mm (e.g., in a range of 0.02 mm to 1.5 mm, inclusive), and W₂ can be less than or equal to 3 mm (e.g., less than or equal to 300 μm, such as in a range of 100-250 μm). In some embodiments, densified, lignin-compromised wood veneer 160 can have an increased density as compared to the natural wood veneer 134. For example, the densified wood veneer 160 can have a density of at least 1.15 g/cm³ (e.g., at least 1.2 g/cm³, or at least 1.3 g/cm³), while the natural wood veneer can have a density less than 1.0 g/cm³ (e.g., less than 0.9 g/cm³, or less than 0.5 g/cm³).

FIG. 1D illustrates aspects for lignin modification and densification of a wood veneer 134 for use in forming a circumferentially-extending wood wall. As with the example of FIG. 1B, the wood veneer 134 at an initial stage 170 prior to lignin modification can have open lumina 136 formed by cellulose-based cell walls in the native microstructure of the wood, and the microstructure can have longitudinally-extending fiber cell walls formed of a composite 140 of cellulose fibrils 142 bonded together by hemicellulose and lignin adhesive matrix 144. The wood veneer 134 can be infiltrated or infused with one or more chemicals, for example, via the native lumina 136. Upon activation (e.g., via heating at an elevated temperature, such as 80-180° C.), the infiltrated chemicals can modify the native lignin in situ. For example, at a subsequent stage 174 after activation, the macromolecular chains of the native lignin can be broken into smaller segments 178, thereby resulting in a more compliant composite 176 for the modified wood veneer 172 while still retaining the open cellulose-based lumina 136 of the native microstructure.

In some embodiments, the infiltrated chemicals can comprise a chemical that produces hydroxide (OH⁻) ions in solution, for example, an alkaline chemical. Since long-term exposure of the wood to alkali can degrade the cellulose (which in turn can lead to a reduction in mechanical properties), the amount of chemicals infiltrated and/or the duration of the heating can be selected to ensure all of the alkaline chemicals within the wood veneer are completely reacted to obtain a neutral softened wood veneer. For example, the OH ions from the infiltrated alkali chemical (e.g., NaOH) can react with the phenolic hydroxyl group in lignin, and, at a same time, OH ions can also cause link bonds in the lignin macromolecules to break, thus shortening the lignin macromolecular chain. As a result of the modified lignin, the wood veneer is softened.

In addition, the lignin degradation products can react with the infiltrated alkali chemical (e.g., NaOH) to form a salt of phenol (e.g., a sodium salt of phenol). Alternatively or additionally, in some embodiments, the alkali chemical infiltrated into the wood veneer can react with native hemicellulose to cause modification (e.g., degradation) thereof. For example, OH⁻ ions can cause degradation of hemicellulose by peeling reaction, thereby producing acidic degradation products. These acidic products can react with the alkali chemical (e.g., NaOH) to form neutral salts that can be immobilized within the final processed plant material. For example, the hemicellulose degradation products can react with the infiltrated alkali chemical (e.g., NaOH) to form salts of alduronic acid (e.g., sodium salts of alduronic acid).

Alternatively or additionally, in some embodiments, the alkali chemical infiltrated into wood veneer can react with native cellulose to cause modification (e.g., degradation) thereof. For example, OH⁻ ions can cause degradation of cellulose by peeling reaction. The degradation products can react with the alkali chemical (e.g., NaOH) to form neutral salts that can be immobilized within the final densified wood veneer 182. For example, the cellulose degradation products can react with the infiltrated alkali chemical (e.g., NaOH) to form salts of gluconate (e.g., sodium salts of gluconate). The reducing end group in the cellulose chain can be prone to elimination under alkali conditions, thereby exposing a new reducing group. The generation of new reductive ends can allow for repeated removal of reductive ends from the cellulose macromolecules. Accordingly, significant amounts of salt (e.g., sodium salt) of gluconate can be formed. In some embodiments, the salt of gluconate in the final in situ lignin-modified wood may be dominant (e.g., as compared to the salt of phenol and/or the salt of alduronic acid).

As a result of the lignin-modified composite 176, the softened wood veneer 172 can be more easily densified. In some embodiments, the pressing for densification may be along a direction substantially perpendicular to, or at least crossing, the longitudinal growth direction (L) of the wood. For example, during a densification stage 180, the lignin-modified veneer 172 can be compressed to form a densified, lignin-compromised veneer 182, with the previously-open cellulose-based lumina 136 now substantially collapsed as shown at 184 in FIG. 1D. In some embodiments, a width, W₁, of the native wood veneer 134 can be at least 2 times (e.g., at least 3-5 times) a width, W₃, of the densified, lignin-compromised wood veneer 182. In some embodiments, the thickness W₃ may be reduced by greater than 60%, 70%, or 80%, as compared to W₁ of the veneer 134, and/or the pressing can result in a compression ratio (W₁:W₃) of 1.1:1 to 10:1. For example, W₁ can be less than or equal to 5 mm (e.g., in a range of 0.02 mm to 1.5 mm, inclusive), and W₃ can be less than or equal to 3 mm (e.g., less than or equal to 300 μm, such as in a range of 100-250 μm). In some embodiments, densified, lignin-compromised wood veneer 182 can have an increased density as compared to the natural wood veneer 134. For example, the densified wood veneer 182 can have a density of at least 1.15 g/cm³ (e.g., at least 1.2 g/cm³, or at least 1.3 g/cm³), while the natural wood veneer 134 can have a density less than 1.0 g/cm³ (e.g., less than 0.9 g/cm³, or less than 0.5 g/cm³).

Referring to FIG. 1F, an exemplary process setup for forming densified, lignin-compromised wood veneer from a natural wood is shown. The natural wood may be in the form of a log or cylindrical bar (e.g., tree trunk 102), with lumina extending (e.g., longitudinal growth direction) in a direction perpendicular to the page. At a cutting stage 188, the natural wood can be cut using a rotary lathe 190, for example, to separate a thin continuous veneer layer 134 of natural wood for subsequent processing. In some embodiments, the natural veneer 134 can be directly conveyed from the cutting stage 188 to a lignin-compromising stage 191, for example, a delignification stage. In the illustrated example, a veneer 134 is immersed in a chemical solution 194 of processing station 192 so as to at least partially remove lignin therein, thus resulting in lignin-compromised veneer 150. Alternatively, in some embodiments, the lignin-compromising stage 191 can be configured for lignin modification, for example, with a processing station to infiltrate a portion of the veneer 134 therein with a chemical solution and a subsequent station to heat the infiltrated veneer to effect the desired in situ modification.

After the lignin-compromising stage 191, the lignin-compromised veneer 150 can be directly conveyed to compression station 196 for pressing in a direction substantially perpendicular to, or at least crossing, the longitudinal growth direction. In the illustrated example of FIG. 1F, a pair of rollers 198 are employed to mechanically press the lignin-compromised veneer 150 therebetween, so as to output the densified, lignin-compromised veneer 160. However, other pressing configurations are also possible according to one or more contemplated embodiments, such as but not limited to, single stationary roller, multiple sequential stationary rollers (e.g., to cumulatively provide a desired compression time), single or multiple movable flat platens, single or multiple movable rollers, or any combination of the foregoing. Alternatively or additionally, the compression station 196 can be configured to heat the veneer 150 and/or one or both of rollers 198 prior to or during the pressing. Other systems and configurations for forming the densified, lignin-compromised wood veneers are also possible according to one or more contemplated embodiments.

Although the description above and elsewhere herein has focused on wood veneers, embodiments of the disclosed subject matter are not limited thereto. Rather, the lignin-modification, densification, and wrapping of rotary cut veneers can be applied to other fibrous plant materials, such as but not limited to natural bamboo. FIG. 1G shows a partial cutaway view of a bamboo segment 151 in its naturally-occurring state. The segment 151 has a culm wall 153 surrounding a hollow interior region 163, which is divided along a length of the culm wall 153 into internal nodal regions 159 by nodes 155 formed by an internal nodal diaphragm 157. The culm wall 153 has fibers extending along a longitudinal direction L (e.g., bamboo growth direction or a direction substantially parallel to an axis defined by the hollow interior region 163) of the bamboo segment 151 that are embedded in a lignin matrix. One or more branch stubs 161 can extend from a particular internal nodal region 159 and can serve as the root from which a culm wall for a new bamboo segment may grow (e.g., thus defining a different longitudinal direction for the new segment).

Within the culm wall 153, the bamboo exhibits a hierarchical cellular structure with porous cells that provide nutrient transport and dense cells that provide mechanical support. For example, FIG. 1H shows images of a cross-section of a bamboo segment 151, in particular, illustrating the microstructure of parenchyma cells 165, vessels 167, and fiber bundles 169 that constitute the culm wall 153. The fiber bundles 169 are highly aligned and extend substantially parallel to the longitudinal direction L whereas parenchyma cells 165 can be parallel or perpendicular to the longitudinal direction L. The density of the fiber bundles 169 can increase along the radial direction, such that an outer portion of the bamboo 151 closest to the exterior surface has different mechanical properties than an inner portion of the bamboo closest to the hollow interior region 163.

Each vessel 167 can define an open lumen that extends along the longitudinal direction L. Moreover, the elementary fibers that form the fiber bundles 169 may also have irregular small lumina in a center thereof. The fiber bundles 169, parenchyma cells 165, and vessels 167 adhere to each other via a polymer matrix composed of lignin and hemicellulose. The native microstructure can also exhibit pit apertures on the longitudinal walls of fibers, porosity introduced by the parenchyma cells, and/or open intercellular space between adjacent fibers. The cut direction of the original piece of bamboo can dictate the orientation of the cell lumina in the final structure. For example, the piece of natural bamboo can be cut in a rotation direction (e.g., perpendicular to the longitudinal growth direction L and along a circumferential direction of the segment 151) such that lumina of longitudinal cells are oriented substantially parallel to the major face of the rotary-cut bamboo piece 171. Embodiments of the disclosed subject matter can compromise the natural polymer matrix in the bamboo piece in order to soften the bamboo for densification and/or further processing.

### Wrapping of Densified, Lignin-Compromised Wood Veneers

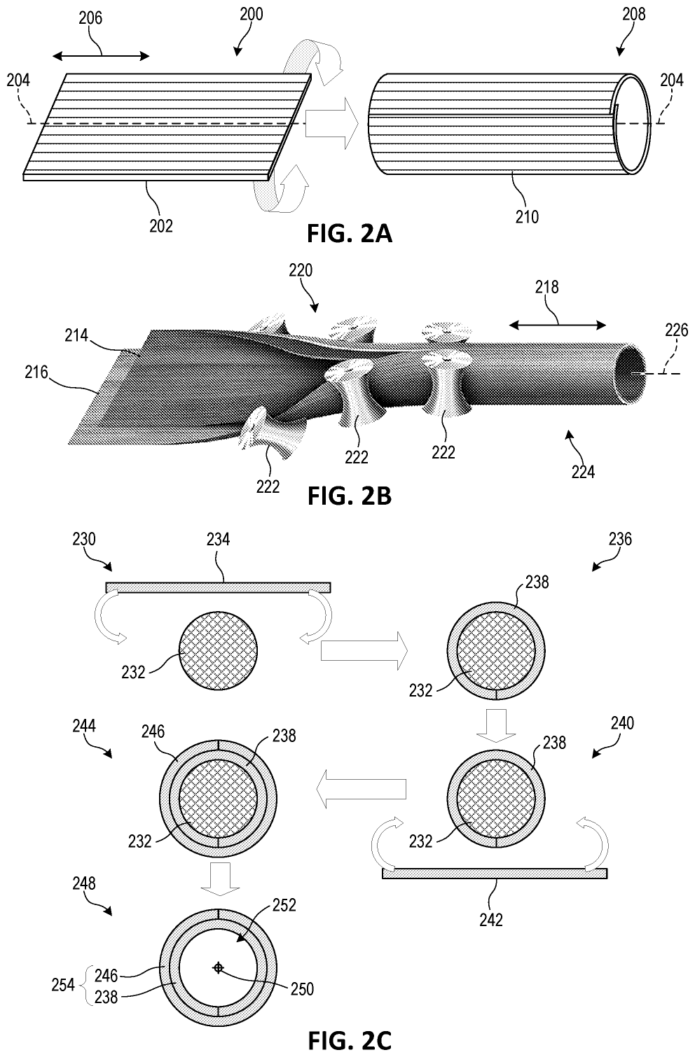

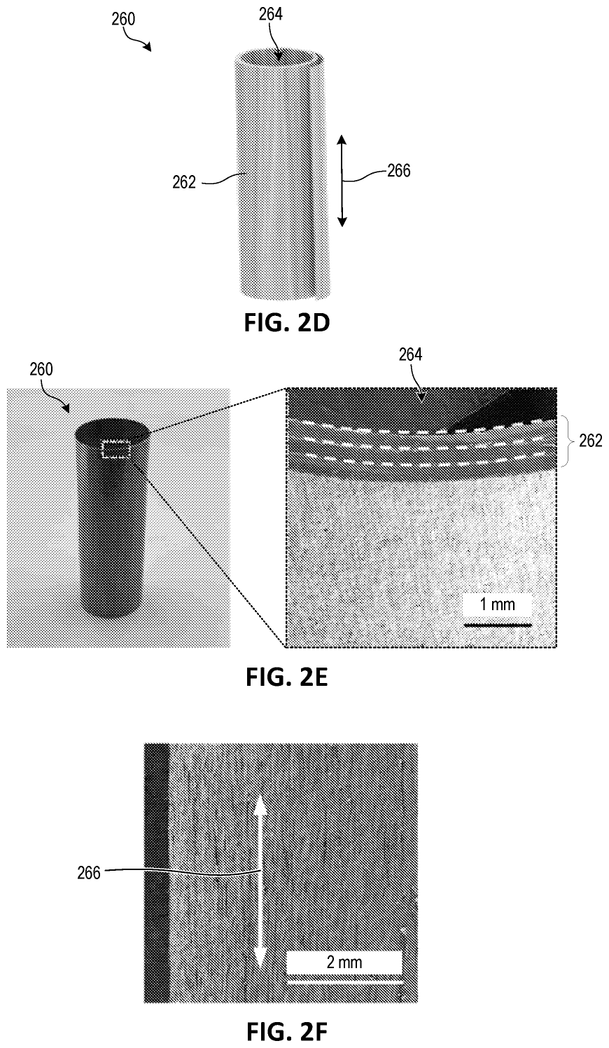

In some embodiments, the strength of the resulting circumferentially-extending wall formed by wrapping one or more densified, lignin-compromised wood veneers about a molding axis can be influenced by a diameter of the circumferentially-extending wall, a thickness of the wall (e.g., the thickness of each wood veneer and the number of wood veneer layers) and/or the orientation of the wood veneers (e.g., a direction of the longitudinal growth direction and/or cellulose fibers with respect to the central axis). In some embodiments, one or more densified, lignin-compromised wood veneers 202 can be wrapped with the longitudinal growth direction 206 being substantially parallel to the molding axis 204, for example, as shown in FIG. 2A. In the illustrated example of FIG. 2A, a single veneer 202 at an initial stage 200 is wrapped around molding axis 204 so as to form circumferentially-extending wood wall 210 at stage 208. The wood wall 210 can be substantially centered on and extend parallel to molding axis 204. Glue can be applied to overlapping edge portions of the single veneer 202 to secure the wall 210 in the wrapped, circumferentially-extending configuration.

In some embodiments, multiple densified, lignin-compromised wood veneers 214, 216 can be simultaneously wrapped about a molding axis 226 to form a circumferentially-extending, multi-layer wood wall 224, as shown in FIG. 2B. In the illustrated example of FIG. 2B, the longitudinal growth direction 218 is substantially parallel to molding axis 226. The first and second wood veneers 214, 216 can be fed in a substantially planar orientation (e.g., parallel to molding axis 226) into an input end of rolling station 220, which comprises a plurality of rollers 222. The rollers 222 can progressively bend the veneers 214, 216 into position around the molding axis 226 to form the multi-layer wood wall 224. In some embodiments, glue can be applied to a part or all of a surface of veneer 214 facing veneer 216 and/or to a part or all of a surface of veneer 216 facing veneer 214. Alternatively or additionally, in some embodiments, glue can be applied to overlapping edge portions of the outermost veneer layer (e.g., veneer 216) to secure the wall 224 in the wrapped, circumferentially-extending configuration.

In some embodiments, multiple densified, lignin-compromised wood veneers 234, 242 can be sequentially wrapped around a molding axis 250 to form a circumferentially-extending multi-layer wood wall 254, as shown in FIG. 2C. As with the examples of FIGS. 2A-2B, the longitudinal growth direction of each veneer 234, 242 can be substantially parallel to molding axis 250. In the illustrated example of FIG. 2C, a molding member 232 (e.g., cylindrical rod) is used to define the wrapped shape of the veneers 234, 242 (or at least the wrapped shape of the innermost veneer layer 238). At a first stage 230, a first densified, lignin-compromised veneer 234 is wrapped around a circumference of the molding member 232, thereby forming an innermost veneer layer 238 at second stage 236. In some embodiments, prior to the wrapping, glue can be applied to a part or all of a surface of veneer 234 facing the molding member 232 and/or to a part or all of an exposed surface of the molding member 232 (e.g., facing the veneer 234). Alternatively or additionally, in some embodiments, glue can be applied to overlapping or abutting edge portions of the wrapped veneer layer 238, for example, prior to, during, or after the wrapping of the first stage 230.

At a third stage 240, a second densified, lignin-compromised veneer 242 is wrapped around a circumference of the innermost veneer layer 238, thereby forming an outermost veneer layer 246 at fourth stage 244. In some embodiments, prior to the wrapping of the third stage 240, glue can be applied to a part or all of a surface of veneer 242 facing the innermost veneer layer 238 and/or to a part or all of an exposed surface of veneer layer 238 (e.g., facing the veneer 242). Alternatively or additionally, in some embodiments, glue can be applied to overlapping or abutting edge portions of the wrapped veneer layer 246, for example, prior to, during, or after the wrapping of the third stage 240. Once the glue dries, the molding member 232 can be removed at fifth stage 248, thereby leaving behind the veneer layers 238, 246 to form the circumferentially-extending wood wall 254. After removal of the molding member 232, the wood wall 254 forms a hollow structure, with an open interior volume 252. In some embodiments, the removal of the molding member 232 can be performed by displacing one or both of the molding member 232 and the wood wall 254 with respect to each other, along a direction parallel to molding axis 250. Alternatively or additionally, in some embodiments, the molding member 232 can be removed by partially or fully dissolving, or otherwise removing in situ (e.g., via melting, sublimation, etching, etc.).

Although FIGS. 2A-2C illustrate each veneer layer extending across an entirety of the circumference of the wood wall, embodiments of the disclosed subject matter are not limited thereto. Rather, in some embodiments, one, some, or each layer of the circumferentially-extending wood wall can be formed of multiple veneers extending over only a portion of the circumference (e.g., with each veneer having a semi-circular shape in cross-sectional view). In addition, although a single veneer layer is shown in FIG. 2A and two veneer layers are shown in FIGS. 2B-2C, any number of veneer layers (e.g., three or more) is also possible according to one or more contemplated embodiments. Indeed, FIGS. 2E-2F illustrate a cylindrical wood tube 260 formed according to the flat wrap orientation of FIG. 2D but with more than two veneer layers. In FIGS. 2D-2F, the cylindrical wood tube 260 has a circumferentially-extending wood wall 262 formed by multiple densified, partially-delignified wood veneer layers and surrounding a hollow interior volume 264. Each wood veneer layer is oriented with its longitudinal growth direction 266 (and direction of cellulose fiber direction therein) extending substantially parallel to the molding axis and the length of the tube 260.

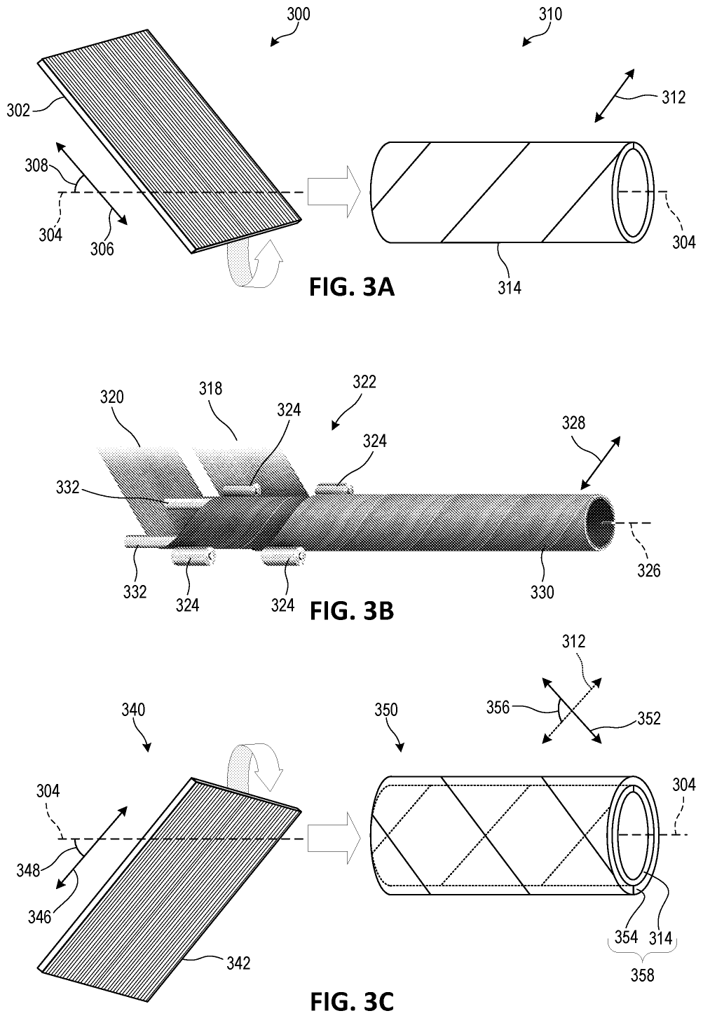

In some embodiments, one or more densified, lignin-compromised wood veneers 302 can be wrapped with the longitudinal growth direction 306 at an angle 308 (e.g., a non-zero, non-orthogonal angle, for example, about) 45° to the molding axis 304, for example, as shown in FIG. 3A. In the illustrated example of FIG. 3A, a single veneer 302 at an initial stage 300 is wrapped around molding axis 304 so as to form circumferentially-extending wood wall 314 at stage 310. The wood wall 314 can be substantially centered on and extend parallel to molding axis 304, but with an orientation 312 of cellulose fibers therein (e.g., having a helix configuration) being non-parallel to the molding axis 304. Glue can be applied to overlapping surface portions of the single veneer 302 to secure the wall 210 in the wrapped, circumferentially-extending configuration. In some embodiments, the use of the angled orientation for the wrapping can allow formation of circumferentially-extending wood walls 314 of arbitrary length (e.g., at least 1 m along a direction parallel to the molding axis 304).

In some embodiments, multiple densified, lignin-compromised wood veneers 318, 320 can be simultaneously wrapped about a molding axis 326 to form a circumferentially-extending, multi-layer wood wall 330, as shown in FIG. 3B. In the illustrated example of FIG. 3B, the longitudinal growth direction 328 for each veneer 318, 320 is non-parallel to molding axis 326, but the orientations of the longitudinal growth directions for the veneers 318, 320 are substantially the same. As a result, the cellulose fibers in each veneer layer of the wood wall 330 are substantially parallel at a same angle. In the illustrated example of FIG. 3B, the first and second wood veneers 318, 320 can be fed in an offset orientation (e.g., crossing a plane containing molding axis 326) into an input end of rolling station 322, which comprises internal rollers 332 and external rollers 324. The rollers 324, 324 can shape the veneers 318, 320 into position around the molding axis 326 to form the multi-layer wood wall 330. In some embodiments, glue can be applied to a part or all of a surface of veneer 318 facing veneer 320 and/or to a part or all of a surface of veneer 320 facing veneer 318. Alternatively or additionally, in some embodiments, glue can be applied to overlapping edge portions of the outermost veneer layer (e.g., veneer 320) to secure the wall 330 in the circumferentially-extending configuration.

In some embodiments, the multiple densified, lignin-compromised wood veneers forming the circumferentially-extending wood wall can have different orientations for their longitudinal growth direction. For example, a second veneer 342 at successive stage 340 can be wrapped around previously wrapped veneer 302, as shown in FIG. 3C. The veneer 342 can be wrapped with its longitudinal growth direction 346 at an angle 348 (e.g., a non-zero, non-orthogonal angle different from that of angle 308, for example, about)−45° to the molding axis 304. In some embodiments, the second veneer 342 can be wrapped in a direction that is opposite to that of the first veneer 302 (e.g., if the first veneer forms a left helix, the second veneer would form a right helix) but at a same angle. Thus, the cellulose fibers in different layers present the same angle to the tube axis 326, but opposite wrap up directions. In some embodiments, the opposite wrapping directions can continue for each subsequent wrapped layer until a desired wall thickness is reached. In the illustrated example of FIG. 3C, the wood wall 358 resulting at a stage 350 includes an innermost veneer layer 314 having an orientation 312 of cellulose fibers therein and an outermost veneer layer 354 having another orientation 352 of cellulose fibers therein. In some embodiments, the orientations 312, 352 in the multi-layer wood wall 358 can be considered a cross-helix configuration. In some embodiments, the orientations 312, 352 can form an angle 356, for example, about 90°.

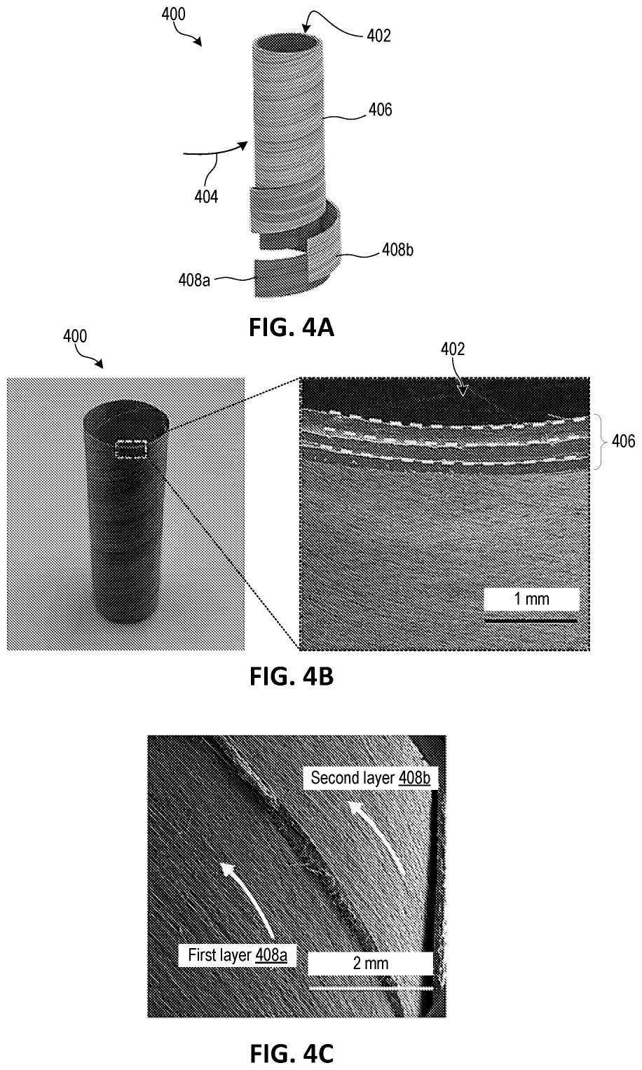

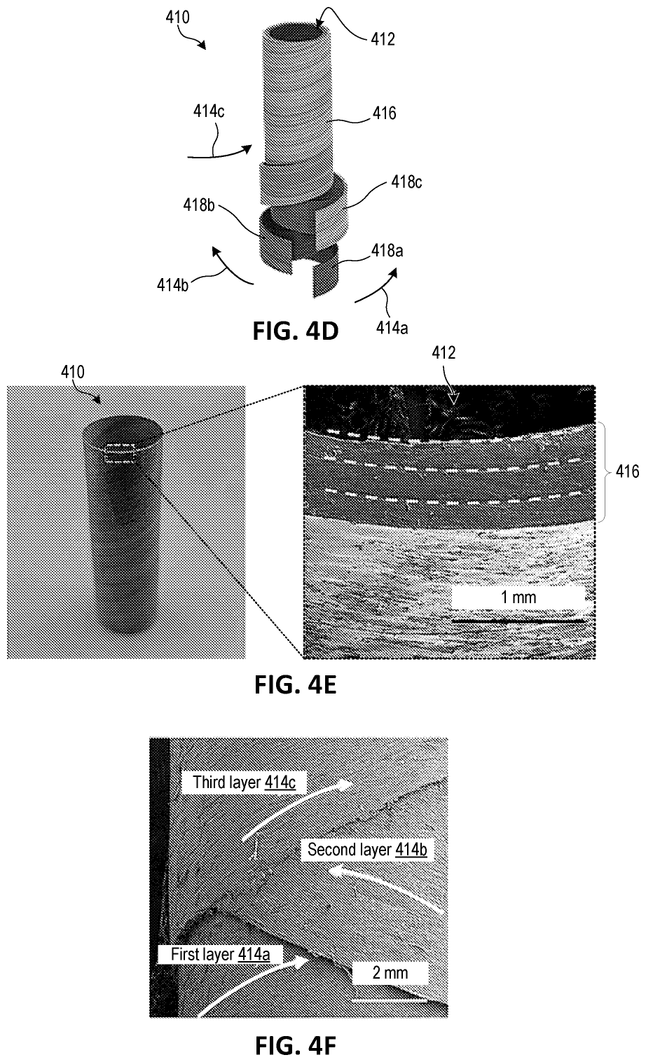

Although FIGS. 3A-3C illustrate each veneer layer extending across an entirety of the circumference of the wood wall, embodiments of the disclosed subject matter are not limited thereto. Rather, in some embodiments, one, some, or each layer of the circumferentially-extending wood wall can be formed of multiple veneers extending over only a portion of the circumference (e.g., with each veneer having a C-shape in cross-sectional view). In addition, although a single veneer layer is shown in FIG. 3A and two veneer layers are shown in FIGS. 3B-3C, any number of veneer layers (e.g., three or more) is also possible according to one or more contemplated embodiments. Indeed, FIGS. 4B-4C illustrate a cylindrical wood tube 400 formed according to the helix configuration of FIG. 4A but with more than two veneer layers, and FIGS. 4E-4F illustrate another cylindrical wood tube 410 formed according to the cross-helix configuration of FIG. 4D but with more than two veneer layers. In FIGS. 4A-4C, the cylindrical wood tube 400 has a circumferentially-extending wood wall 406 formed by multiple densified, partially-delignified wood veneer layers and surrounding a hollow interior volume 402. Each wood veneer layer (e.g., 408a-408b in FIGS. 4A and 4C) is oriented with its longitudinal growth direction 404 (and direction of cellulose fiber direction therein) extending at an angle to the molding axis and the length of the tube 400. In FIGS. 4D-4F, the cylindrical wood tube 410 has a circumferentially-extending wood wall 416 formed by multiple densified, partially-delignified wood veneer layers 414a-414c and surrounding a hollow interior volume 412. Each wood veneer layer 414a-414c is oriented with its respective longitudinal growth direction 418a-418c at an angle to the molding axis and the length of the tube 410. However, for each wood veneer layer 414a-414c, the respective longitudinal growth direction 418a-418c is in an opposite direction from that of the wood veneer layers immediately adjacent thereto. For example, the first and third layers 414a, 414c have orientations along a same direction (e.g., substantially parallel), whereas the second direction 414b has an orientation opposite to the first and third layers, as shown in FIG. 4F.

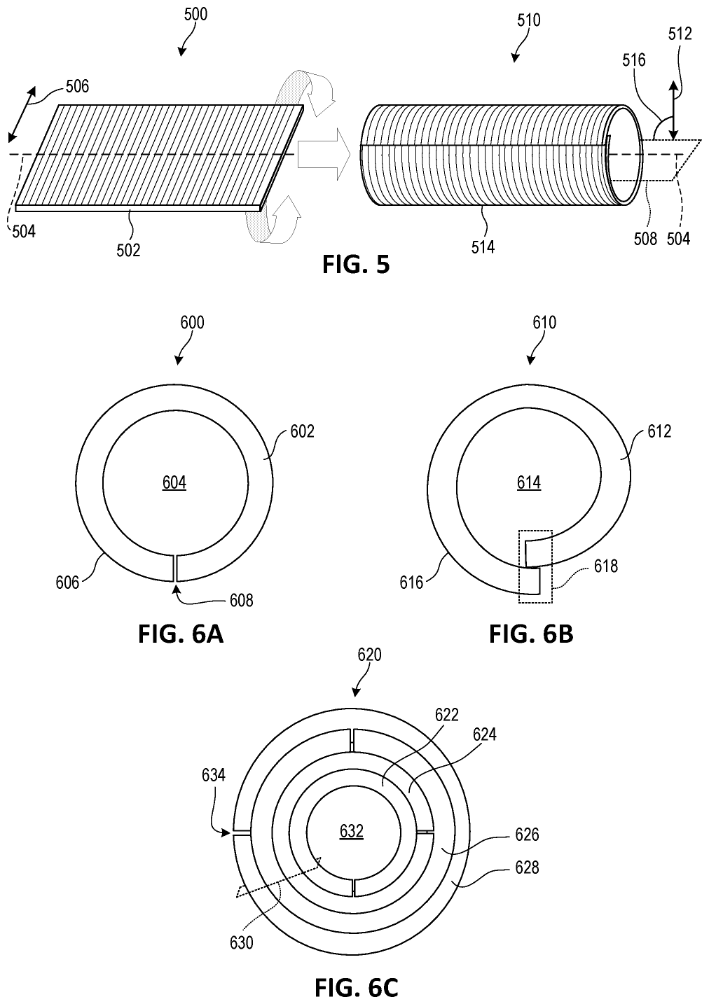

In some embodiments, one or more densified, lignin-compromised wood veneers 502 can be wrapped with the longitudinal growth direction 506 aligned with the circumferential direction (e.g., such that an orientation 512 of cellulose fibers therein are at an angle 516, for example, about 90°, to a plane 508 containing the molding axis 504), for example, as shown in FIG. 5. In the illustrated example of FIG. 5, a single veneer 502 at an initial stage 500 is wrapped around molding axis 504 so as to form circumferentially-extending wood wall 514 at stage 510. The wood wall 514 can be substantially centered on and extend parallel to molding axis 504. Glue can be applied to overlapping surface portions of the single veneer 502 to secure the wall 514 in the wrapped, circumferentially-extending configuration.

### Tubes Formed by Fibrous Plant Material Veneers

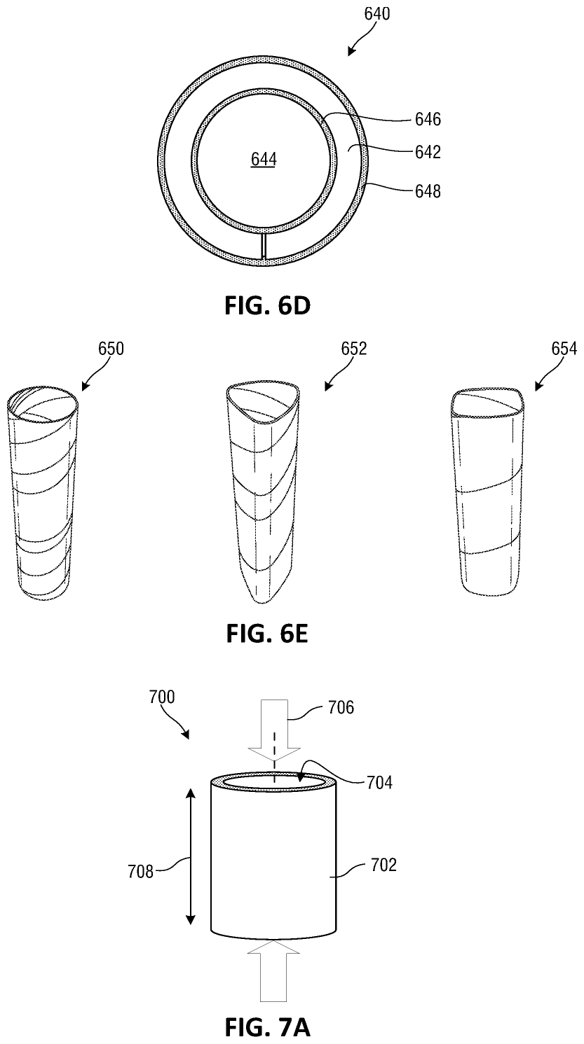

In some embodiments, a densified, lignin-compromised fibrous plant material veneer can be wrapped to form a hollow structure, for example, a substantially-cylindrical tube or pipe. For example, FIG. 6A illustrates a hollow structure 600 comprising a single fibrous plant material veneer 606. The veneer 606 is wrapped around a central axis to form a circumferentially-extending fibrous plant material wall 602 that encloses an interior volume 604. In the illustrated example, of FIG. 6A, opposite side edges of the veneer 606 can face and/or abut each other, thereby forming a junction 608. In some embodiments, glue can be applied at the junction 608 to secure the veneer 606 in the desired wrapped shape. Alternatively or additionally, in some embodiments, veneer 616 can overlap with itself along the circumferential direction (e.g., at side edge portions) to enclose an interior volume 614 and form a junction 618, for example, as shown by the circumferentially-extending wall 612 in the hollow structure 610 of FIG. 6B. The junction 618 can have an increased thickness along the radial direction as compared to a remainder of the veneer. In some embodiments, glue can be applied at the junction 618 to secure the veneer 616 in the desired wrapped shape. Alternatively or additionally, some or all surfaces of veneer 606 and/or veneer 616 can be coated in glue, such that the rigidity of the veneer increases once the glue has dried, thereby retaining the veneer in the desired wrapped shape.

In some embodiments, multiple densified, lignin-compromised veneers can be wrapped to form a hollow structure, for example, a substantially-cylindrical tube or pipe. For example, FIG. 6C illustrates a hollow structure 620 comprising four veneer layers 622, 624, 626, and 628 that form a circumferentially-extending fibrous plant material wall 630. The innermost fibrous plant material veneer 622 is wrapped around a central axis to enclose an interior volume 632, whereas the other veneers 624-628 are successively wrapped over the more radially-inward veneers. In the illustrated example, opposite side edges of each veneer can face and/or abut each other, thereby forming a respective junction (only 634 is labeled in FIG. 6C for clarity). In some embodiments, each junction can be offset along the circumferential direction of the structure 620 from the other junctions, or at least the junctions of adjacent veneers in the wall 630, for example, to enhance a strength of the wall 630. In some embodiments, glue can be applied at each veneer junction (e.g., 634) to secure the veneer in the desired wrap shape. Alternatively or additionally, an exposed radial surface of each veneer, or portion thereto, can be coated in glue in order to bond to a facing radial surface of another veneer. Alternatively or additionally, some or all surfaces of veneers 622, 624, 626, and/or 628 can be coated in glue, such that the rigidity of the veneer increases once the glue has dried, thereby retaining the veneer in the desired wrapped shape.

In some embodiments, the hollow structure formed by the one or more densified, lignin-compromised veneers can be combined with one or more non-plant material (e.g., non-wood) layers to form a composite structure. For example, FIG. 6D illustrates a composite hollow structure 640 having a circumferentially-extending wall 642 formed by wrapping one or more densified, lignin-compromised veneers about a central axis and enclosing an interior volume 644. Over an interior surface of the wall 642, a first non-plant layer 646 can be disposed. Alternatively or additionally, a second non-plant layer 648 can be disposed over an exterior surface of the wall 642. In some embodiments, the first non-plant layer 646, the second non-plant layer 648, or both can be formed of a concrete, metal, or polymer. In some embodiments, a thickness of the first non-plant layer 646, the second non-plant layer 648, or both can be less than a thickness of the circumferentially-extending fibrous plant material wall 642, for example, less than or equal to 50% of the fibrous plant material wall thickness. In some embodiments, the second non-plant layer 648 can be provided (e.g., deposited, coated, laminated, etc.) on the fibrous plant material wall 642, for example, after the veneers are wrapped and any glue has dried. Alternatively or additionally, in some embodiments, the first non-plant layer 646 can be provided (e.g., deposited, coated, laminated etc.) on the fibrous plant material wall 642, for example, after the veneers are wrapped and any glue has dried. Alternatively or additionally, in some embodiments, the first non-plant layer 646 can be performed (e.g., as a tube or pipe) and can be used as a molding member about which the fibrous plant material veneers are wrapped to form the wall 642.

Although the discussion above has primarily focused on hollow structures with cylindrical cross-sections, embodiments of the disclosed subject matter are not limited thereto. Indeed, any cross-sectional shape for the circumferentially-extending fibrous plant material wall is possible according to one or more contemplated embodiments. For example, FIG. 6E shows hollow wood structures fabricated with a circular cross-section 650, a triangular cross-section 652, and a rectangular cross-section 654.

### Energy Absorbing Structures

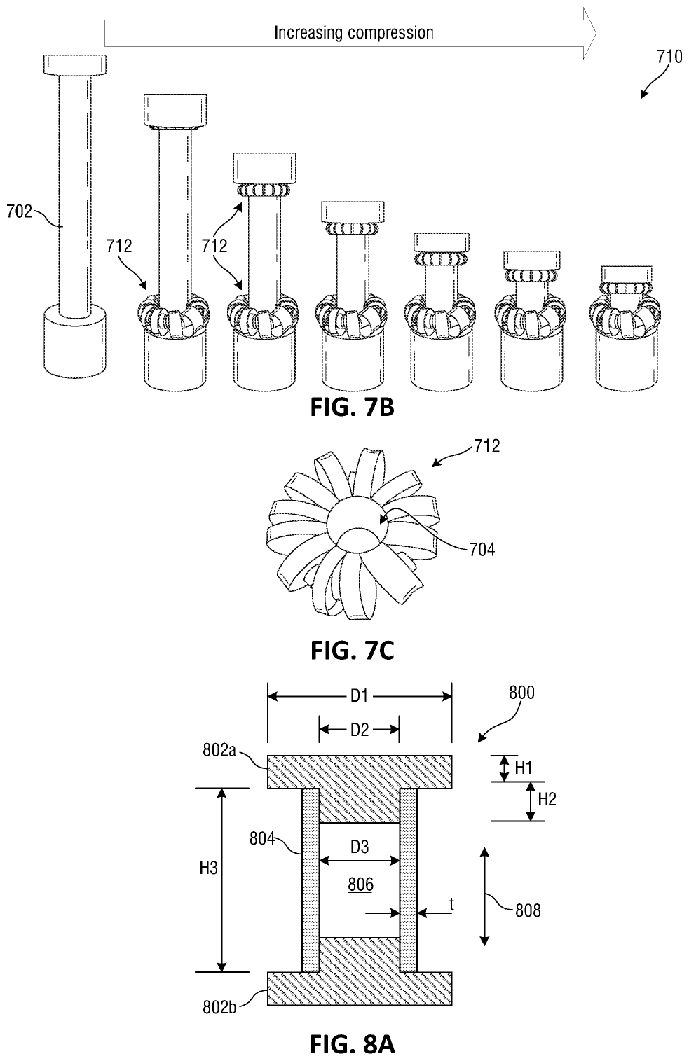

In some embodiments, the densified, lignin-compromised fibrous plant material veneers can be strong in a direction along the cellulose fibers (e.g., having a mechanical strength of about 650 MPa), but relatively weak in a direction perpendicular to the cellular fibers (e.g., having a mechanical strength of about 20 MPa). As a result, flat-wrapped orientations (e.g., with the longitudinal growth direction 708 parallel to the molding axis 706) for forming a circumferentially-extending wood wall 702 can be anisotropic-relatively strong when subjected to forces parallel to the molding axis 706 (e.g., along the axial direction) as shown in the setup 700 of FIG. 7A, but relatively weak when subjected to forces perpendicular to the molding axis 706 (e.g., along a radial direction). In addition, when subjected to axial compression as in FIG. 7A, the flat-wrapped wood tube 702 can exhibit a unique failure mode that is distinct from tubes made of isotropic materials. In some embodiments, this failure mode can increase the energy absorbing capabilities of the flat-wrapped wood wall 702.

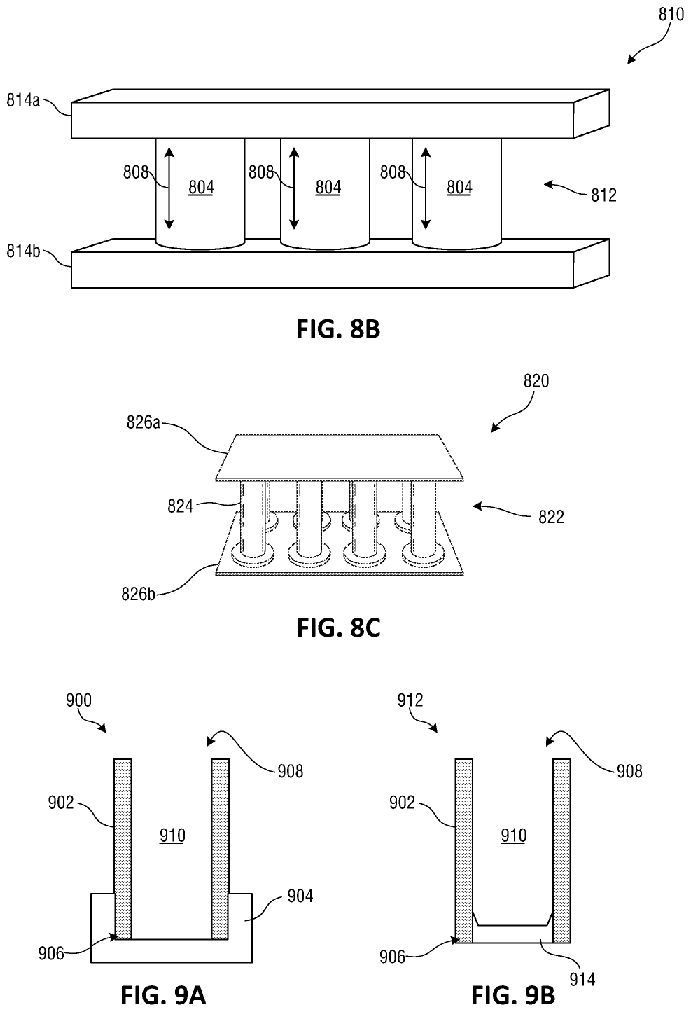

When loaded in axial compression by two end caps, as shown in the testing progression 710 of FIGS. 7B-7C, the flat-wrapped wood tube 702 fractures in a petaling failure mode 712, which starts from one end or both ends of the tube 702 and advances along the axial direction stably as the two end caps come closer. By contrast, when an isotropic tube made of aluminum is subjected to similar axial compression, the failure features severe local distortion of the tube due to buckling. Referring to FIG. 8A, an exemplary configuration 800 for the compression loading is shown, with end caps 802a, 802b being inserted into an opposite axial end of a flat-wrapped wood tube 804, with a hollow volume 806 therebetween. In the illustrated example, each end cap 802 had an outer diameter, D1, of 25.5 mm, an inner diameter, D2, of 12.67 mm, a flange height, H1, of 10.8 mm, and an insert height, H2, of 10.1 mm, and the wood tube 804 had an inner diameter, D3, of 12.75 mm, a flange-to-flange length, H3, of 100 mm, and a wall thickness, t, of 0.64 mm.

At about 2% of compressive strain, multiple cracks initiate along the axial direction at the end of the tube 704 in contact with the end cap due to the anisotropic mechanical behaviors of the tube. As the two end caps further come closer to each other, the initial cracks propagate in parallel along the axial direction, leading to the splitting of the tube into strips in the wake of the cracks. These densified, lignin-compromised wood strips curl outward as the cracks propagate continuously along the axial direction, forming the petal-like failure morphology of the tube, as shown in FIGS. 7B-7C.

In some embodiments, the high energy absorption offered by the petaling failure mode in the flat-wrapped wood wall can be exploited in an energy absorption device (e.g., a car bumper, building crush protection, etc.). For example, FIG. 8B illustrates an energy absorbing structure 810 formed by an array 812 of flat-wrapped wood tubes 804 (each with their longitudinal growth direction 808 aligned with an axis of the tube 804) disposed between a pair of support members 814a, 814b. The support members 814a, 814b can be formed of any material (e.g., metal, such as aluminum). In some embodiments, the support members 814a, 814b can be coupled to the wood tubes 804 via respective end caps (e.g., similar to compression caps 802 in FIG. 8A; not shown in FIG. 8B). Application of a sufficient force (e.g., impact or compression) between the support members 814a, 814b can thus be absorbed and/or dissipated by the petaling failure of one or more of the tubes 804. Although a linear array 812 of only three tubes 804 is shown in FIG. 8B, embodiments of the disclosed subject matter are not limited thereto. Rather, any number of tubes 804 and arrangement thereof is possible according to one or more contemplated embodiments, such as but not limited to the rectangular array 822 of tubes 824 between aluminum plates 826a. 826b in the energy absorbing structure 820 of FIG. 8C.

### Closed-End and Solid Structures Formed by Fibrous Plant Material Veneers

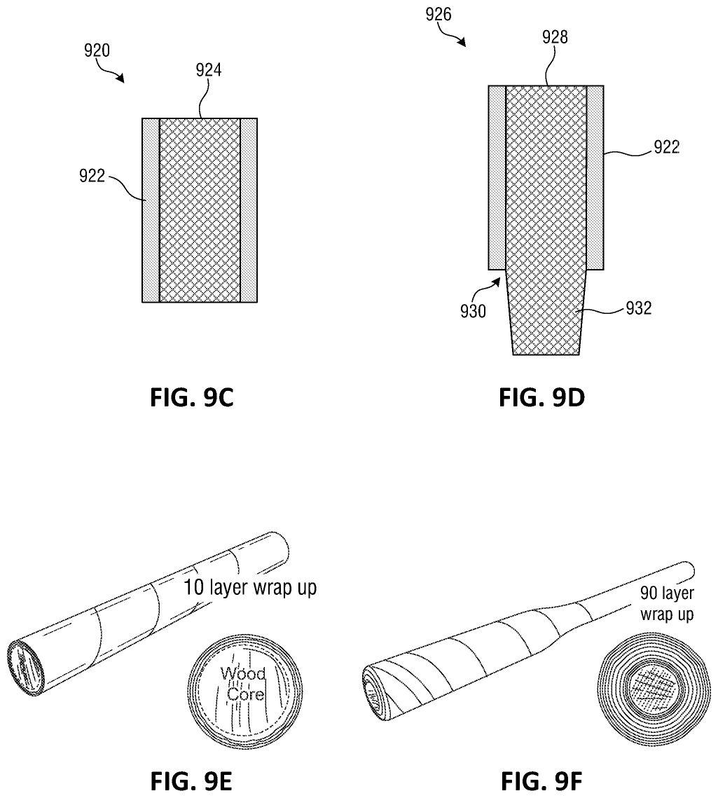

Although the description above and elsewhere herein has focused on open-end hollow structures, embodiments of the disclosed subject matter are not limited thereto. Rather, in some embodiments, the circumferentially-extending wall formed by wrapping one or more densified, lignin-compromised fibrous plant material veneers about a central axis can be part of a closed-end hollow structure and/or a solid structure. For example, FIG. 9A illustrates a closed-end hollow structure 900 (e.g., a closed-end tube, cup, tank, or bottle) having a circumferentially-extending fibrous plant material wall 902 surrounding an interior volume 910. A second member 904 can be coupled to and can close one end 906 of the wall 902, while an opposite end 908 of the wall 902 may remain open. The second member can be formed of any material, for example, natural fibrous plant material, metal, polymer, cork, concrete, densified fibrous plant material, densified lignin-compromised fibrous plant material, or any combination thereof. In the illustrated example of FIG. 9A, the second member 904 can extend over and/or attach to an exterior portion of the wall 902. Alternatively or additionally, a second member 914 can extend over and/or attach to an interior portion of the wall 902, for example, as shown in by the configuration 912 of FIG. 9B.

FIG. 9C illustrates solid structure 920 (e.g., rod, dowel, bat, or club) having a circumferentially-extending fibrous plant material wall 922 surrounding a central member 924. The central member 924 can be formed of any material, for example, natural fibrous plant material, metal, cork, concrete, densified fibrous plant material, lignin-compromised fibrous plant material, densified lignin-compromised fibrous plant material, or any combination thereof. For example, FIG. 9E illustrates a fabricated solid structure formed by wrapping ten densified, partially-delignified wood veneers around a wood core, and FIG. 9F illustrates a fabricated solid structure formed by wrapping ninety densified, partially-delignified wood veneers around a wood core. In the illustrated example of FIG. 9C, the central member 924 is contained within an axial length wood wall 922. However, in some embodiments, the central member may extend beyond one or both ends of the fibrous plant material wall. For example, the central member 928 in the solid structure 926 of FIG. 9D has an extension portion 932 that extends from a first end 930 of the circumferentially-extending wood wall 922.

### Fabrication Methods

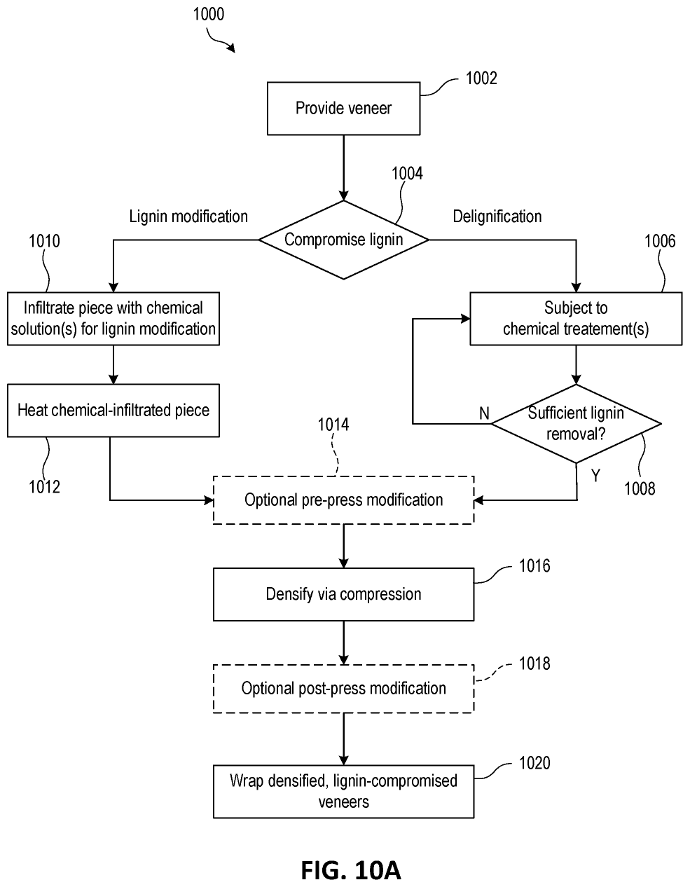

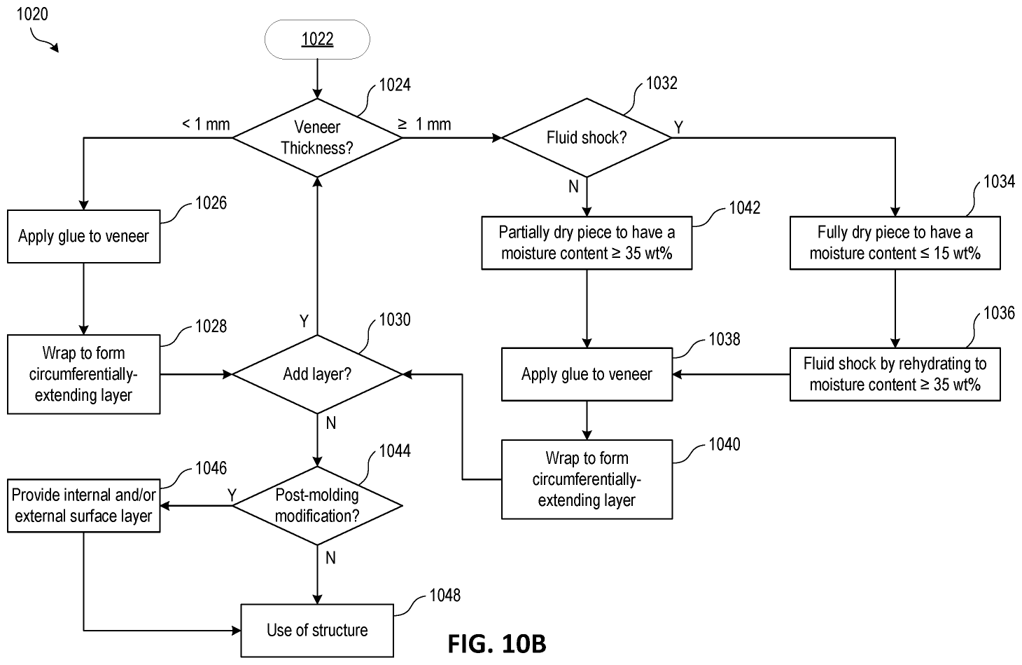

Referring to FIG. 10A, a method 1000 for fabricating densified, lignin-compromised fibrous plant material veneers is shown. The method 1000 can begin at process block 1002, where a veneer of natural fibrous plant material is prepared. For example, the preparing of process block 1002 can include cutting, removing, or otherwise separating the veneer of natural fibrous plant material from a parent structure (e.g., tree). In some embodiments, the cutting can form the veneer into a substantially flat planar structure, with a direction of cellulose fibers extending parallel to a plane of the structure. Optionally, in some embodiments, the preparing can include pre-processing of the veneer of natural fibrous plant material, for example, cleaning to remove any undesirable material or contamination in preparation for subsequent processing, forming the fibrous plant material into a particular shape in preparation for subsequent processing (e.g., slicing into strips), or any combination of the foregoing. In some embodiments, the preparing of process block 1002 involves obtaining one or more veneers via rotary cut.

The method 1000 can proceed to decision block 1004, where it is determined if the veneer will be subjected to lignin modification or delignification. If delignification is desired, the method 1000 proceeds to process block 1006, where the natural fibrous plant material veneer is subjected to one or more chemical treatments to remove at least some lignin therefrom, for example, by immersion of the natural fibrous plant material veneer (or a portion thereof) in a chemical solution associated with the treatment. In some embodiments, each chemical treatment or only some chemical treatments can be performed under vacuum, such that the solution associated with the treatment is encouraged to fully penetrate the cell walls and lumina of the natural fibrous plant material veneer. Alternatively, in some embodiments, the chemical treatment(s) can be performed under ambient pressure conditions or elevated pressure conditions (e.g., ˜6-8 bar). In some embodiments, each chemical treatment or some chemical treatments can be performed at any temperature between ambient (e.g., ˜23° C.) and an elevated temperature where the solution associated with the chemical treatment is boiling (e.g., ˜70-160° C.). In some embodiments, the solution is not agitated in order to minimize the amount of disruption to the microstructure of the natural fibrous plant material.

In some embodiments, the immersion time can range anywhere from 0.1 hours to 96 hours, for example, between 1 hours and 12 hours, inclusive. The amount of time of immersion within the solution may be a function of the amount of lignin to be removed, type of fibrous plant material, size of the veneer, temperature of the solution, pressure of the treatment, and/or agitation. For example, smaller amounts of lignin removal, smaller veneer size (e.g., thickness), higher solution temperature, higher treatment pressure, and agitation may be associated with shorter immersion times, while larger amounts of lignin removal, larger veneer size, lower solution temperature, lower treatment pressure, and no agitation may be associated with longer immersion times.

In some embodiments, the solution of the chemical treatment comprises an alkaline solution. In some embodiments, the solution of the chemical treatment can include sodium hydroxide (NaOH), lithium hydroxide (LiOH), potassium hydroxide (KOH), sodium sulfite (Na₂SO₃), sodium sulfide (Na₂S), NaₙS (where n is an integer), urea (CH₄N₂O), sodium bisulfite (NaHSO₃), sulfur dioxide (SO₂), anthraquinone (AQ) (C₁₄H₈O₂), methanol (CH₃OH), ethanol (C₂H₅OH), butanol (C₄H₉OH), formic acid (CH₂O₂), hydrogen peroxide (H₂O₂), acetic acid (CH₃COOH), butyric acid (C₄H₈O₂), peroxyformic acid (CH₂O₃), peroxyacetic acid (C₂H₄O₃), ammonia (NH₃), tosylic acid (p-TsOH), sodium hypochlorite (NaClO), sodium chlorite (NaClO₂), chlorine dioxide (ClO₂), chlorine (Cl₂), or any combination of the above. Exemplary combinations of chemicals for the chemical treatment can include, but are not limited to, NaOH+Na₂SO₃, NaOH+Na₂S, NaOH+urea, NaHSO₃+SO₂+H₂O, NaHSO₃+Na₂SO₃, NaOH+Na₂SO₃, NaOH+AQ, NaOH+Na₂S+AQ, NaHSO₃+SO₂+H₂O+AQ. NaOH+Na₂SO₃+AQ, NaHSO₃+AQ, NaHSO₃+Na₂SO₃+AQ, Na₂SO₃+AQ, NaOH+Na₂S+NaₙS (where n is an integer), Na₂SO₃+NaOH+CH₃OH+AQ, C₂H₅OH+NaOH, CH₃OH+HCOOH, NH₃+H₂O, and NaClO₂+acetic acid.

The chemical treatment can continue (or can be repeated with subsequent solutions) until a desired reduction in lignin content in the fibrous plant material veneer is achieved at decision block 1008. The lignin content can be reduced to between 0.1% (lignin content is 0.1% of original lignin content in the natural fibrous plant material) and 99% (lignin content is 99% of original lignin content in the natural fibrous plant material), depending upon the desired application. For example, in some embodiments where it may be desirable to retain as much of the natural fibrous plant material as possible, the reduction in lignin content can be relatively small, for example, such that the lignin content is reduced by no more than 10% as compared to the original lignin content of the natural fibrous plant material. In some embodiments, greater amounts of lignin can be removed, such as at least 90% of the original lignin content is removed (e.g., 90-100% lignin removed). In some embodiments, the lignin content is reduced by 50% or less as compared to the original lignin content in the natural fibrous plant material. In some embodiments, the chemical treatment reduces the hemicellulose content at the same time as the lignin content, for example, to the same or lesser extent as the lignin content reduction. In some embodiments, when the fibrous plant material veneer is hardwood or bamboo, the lignin content after the delignification of process block 1006 can be at least 10 wt % (e.g., in a range of 10-15 wt %, inclusive). In some embodiments, when the fibrous plant material veneer is softwood, the lignin content after the delignification of process block 1004 can be at least 12.5 wt % (e.g., 12.5-17.5 wt %, inclusive).

In some embodiments, process block 1006 and/or decision block 1008 (e.g., before proceeding to process block 1014) can further include an optional rinsing step after the chemical treatment(s), for example, to remove residual chemicals or particulate resulting from the delignification process. For example, the delignified veneer can be partially or fully immersed in one or more rinsing solutions. The rinsing solution can be a solvent, such as but not limited to, de-ionized (DI) water, alcohol (e.g., ethanol, methanol, isopropanol, etc.), or any combination thereof. For example, the rinsing solution can be formed of equal volumes of water and ethanol. In some embodiments, the rinsing can be performed without agitation, for example, to avoid disruption of the microstructure. In some embodiments, the rinsing may be repeated multiple times (e.g., at least 3 times) using a fresh mixture rinsing solution for each iteration.

If lignin modification is instead desired at decision block 1004, the method 1000 can proceed to process block 1010, wherein the natural fibrous plant material veneer can be infiltrated with one or more chemicals to modify lignin therein. For example, in some embodiments, the infiltration can be by soaking the natural fibrous plant material veneer in a solution containing the one or more chemicals under vacuum. In some embodiments, the chemical solution can contain at least one chemical component that has OH ions or is otherwise capable of producing OH ions in solution. In some embodiments, one, some, or all of the chemicals in the solution can be alkaline. In some embodiments, the chemical solution includes p-toluenesulfonic acid, NaOH, LiOH, KOH, Na₂O, or any combination thereof. Exemplary combinations of chemicals can include, but are not limited to, p-toluenesulfonic acid, NaOH, NaOH+Na₂SO₃/Na₂SO₄, NaOH+Na₂S, NaHSO₃+SO₂+H₂O, NaHSO₃+Na₂SO₃, NaOH+Na₂SO₃, NaOH/NaH₂O₃+AQ, NaOH/Na₂S+AQ, NaOH+Na₂SO₃+AQ, Na₂SO₃+NaOH+CH₃OH+AQ, NaHSO₃+SO₂+AQ. NaOH+Na₂Sx, where AQ is Anthraquinone, any of the foregoing with NaOH replaced by LiOH or KOH, or any combination of the foregoing.

For example, in some embodiments, a wood veneer (e.g., basswood) can be immersed in a chemical solution (e.g., 2-5% NaOH) in a container. The container can then be placed in a vacuum box and subjected to vacuum. In this way, the air in the veneer can be drawn out and form a negative pressure. When the vacuum pump is turned off, the negative pressure inside the veneer can suck the solution into the veneer through the natural channels therein (e.g., lumina defined by longitudinal cells). The process can be repeated more than once (e.g., 3 times), such that the channels inside the veneer can be filled with the chemical solution (e.g., about 2 hours). After this process, the moisture content can increase from ˜10.2% (e.g., for natural wood) to ˜70% or greater. In some embodiments, the chemical infiltration can be performed without heating, e.g., at room temperature (20-30° C., such as ˜22-23° C.). In some embodiments, the chemical solution is not agitated in order to avoid disruption to the cellulose-based microstructure of the veneer.

The method 1000 can proceed to process block 1012, where the modification may be activated by subjecting the infiltrated veneer to an elevated temperature, for example, greater than 80° C. (e.g., 80-180° C., such as 120-160° C.), thereby resulting in a softened veneer (e.g., softened as compared to the native fibrous plant material veneer). In some embodiments, the subjecting to an elevated temperature of process block 1012 can be achieved via steam heating, for example, via steam generated in an enclosed reactor, via a steam flow in a flow-through reactor, and/or via steam from a superheated steam generator. Alternatively or additionally, in some embodiments, the subjecting to an elevated temperature of process block 1012 can be achieved via dry heating, for example, via conduction and/or radiation of heat energy from one or more heating elements without separate use of steam. In some embodiments, during process block 1012, the infiltrated veneer can be subjected to the elevated temperature for a first time period of, for example, 1-5 hours (e.g., depending on the size of the veneer, with thicker pieces requiring longer heating times). In some embodiments, after the first time period, any steam generated by heating of the infiltrated veneer can be released, for example, by opening a pressure release (e.g., relief valve) of the reactor. For example, in some embodiments, the pressure release can be effective to remove ˜50% of moisture in the modified veneer. For example, in some embodiments, the now softened veneer can have a moisture content in a range of 30-50 wt %, inclusive. In some embodiments, the veneer can be further dried to reduce the moisture content of the veneer, but without removing too much moisture that the fibrous plant material veneer loses its softened nature (e.g., such that the moisture content is greater than or equal to ˜8-10 wt %). In some embodiments, the pre-drying may be effective to reduce a moisture content of the fibrous plant material veneer from greater than 30 wt % (e.g., 30-50 wt %) to within a range of, for example, 10-20 wt % (e.g., ˜15 wt %). While moisture may be removed from the softened veneer via the heating and/or pre-drying (e.g., via evaporation), the removed moisture may be substantially free of residual salts and/or chemicals from the in situ lignin-modification. Rather, in some embodiments, the chemicals can be substantially consumed by the modification, and the residual salts can be retained within the microstructure of the softened veneer.

After process block 1012 or decision block 1008, the method can proceed to process block 1014, where an optional pre-press modification can be performed. In some embodiments, the pre-press modification can comprise an internal modification of the lignin-compromised fibrous plant material veneer. Although the term “internal” is used to refer to the modification of process block 1014, it is contemplated that, in some embodiments, the modification may be applied to external features as well as internal features of the lignin-compromised fibrous plant material veneer, while in other embodiments the modification may be applied to either internal features or external features of the lignin-compromised fibrous plant material veneer without otherwise affecting the other feature. In some embodiments, the internal modification can include forming, depositing, or otherwise providing non-native particles on surfaces of the lignin-compromised fibrous plant material veneer. Such surfaces can include at least internal surfaces, e.g., cell walls lining the lumina, but may also include external surfaces of the lignin-compromised fibrous plant material veneer. The non-native particles incorporated onto the surfaces of the lignin-compromised fibrous plant material veneer can imbue the final structure with certain advantageous properties, such as hydrophobicity, weatherability, corrosion resistance (e.g., salt water resistant), and/or flame resistance among other properties. For example, in some embodiments, hydrophobic nanoparticles (e.g., SiO₂ nanoparticles) can be formed on surfaces of the lignin-compromised fibrous plant material veneer.

Alternatively or additionally, in some embodiments, the internal modification can include performing a further chemical treatment that modifies the surface chemistry of the lignin-compromised fibrous plant material veneer. For example, in some embodiments, the further chemical treatment can provide weatherability or corrosion resistance can include at least one of cupramate (CDDC), ammoniacal copper quaternary (ACQ), chromated copper arsenate (CCA), ammoniacal copper zinc arsenate (ACZA), copper naphthenate, acid copper chromate, copper citrate, copper azole, copper 8-hydroxyquinolinate, pentachlorophenol, zinc naphthenate, copper naphthenate, creosote, titanium dioxide, propiconazole, tebuconazole, cyproconazole, boric acid, borax, organic iodide (IPBC), and Na₂B₈O₁₃·4H₂O.

Alternatively or additionally, in some embodiments, the internal modification of process block 1014 can include infiltrating the lignin-compromised fibrous plant material veneer with one or more polymers (or polymer precursors) to form a composite material. For example, the lignin-compromised fibrous plant material veneer can be immersed in a polymer solution under vacuum. The polymer can be any type of polymer capable of infiltrating into the pores of the softened plant material, for example, a synthetic polymer, a natural polymer, a thermosetting polymer, or a thermoplastic polymer. In some embodiments, the polymer-infiltrated fibrous plant material composite can allow the subsequently densified veneers to be wrapped without breaking, cracking, or otherwise compromising the structure of the veneer, for example, when a thickness of the veneer is greater than or equal to 1 mm. In some embodiments, the polymer infiltration can be performed after drying of the veneer but before the pressing of process block 1016. Alternatively, in some embodiments, the polymer infiltration can be performed after drying and/or after a partial pressing of the veneer, but before the pressing of process block 1016.

For example, in some embodiments, the polymer can be epoxy resin, polyvinyl alcohol (PVA), polyethylene glycol (PEO), polyamide (PA), polyethylene terephthalate (PET), polybutylene terephthalate (PBT), polytrimethylene terephthalate (PTT), polyacrylonitrile (PAN), polycaprolactam (PA6), poly(m-phenylene isophthalamide) (PMIA), poly-p-phenylene terephthalamide (PPTA), polyurethane (PU), polycarbonate (PC), polypropylene (PP), high-density polyethylene (HDPE), polystyrene (PS), polycaprolactone (PCL), polybutylene succinate (PBS), polybutylene adipate terephthalate (PBAT), poly(butylene succinate-co-butylene adipate) (PBSA), polyhydroxybutyrate (PHB), poly(3-hydroxybutyrate-co-3-hydroxyvalerate) (PHBV), poly(glycolic acid) (PGA), polypyrrole (PPy), polythiophene (PTh), polyvinylidene fluoride (PVDF), polyvinyl fluoride (PVF), ethylene vinyl alcohol (EVOH), poly(vinylidene chloride) (PVDC), polyxylylene adipamide (MXD6), polyethylene (PE), polyvinyl chloride (PVC), poly(methyl methacrylate) (PMMA), acrylonitrile butadiene styrene (ABS), polyimide (PI), polyethylenimine (PEI), polylactic acid (PLA), octadecyl trichlorosilane (OTS), polyoctahedral silsesquioxane (POSS), paramethylstyrene (PMS), polydimethylsiloxane (PDMS), poly(ethylene naphthalate (PEN), a graft copolymer of acrylonitrile-butadiene-styrene-methylmethacrylate (ABSM), dodecyltrimethoxysilane (DTMS), rosin, chitin, chitosan, protain, plant oil, lignin, hemicellulose, carboxymethyl cellulose, cellulose acetate, starch, agar, or any combination of the above.

The method 1000 can proceed to process block 1016, where the lignin-compromised veneer is pressed in a direction crossing its longitudinal growth direction. In some embodiments, the pressing can be in a direction substantially perpendicular to the longitudinal growth direction, while in other embodiments the pressing may have a force component perpendicular to the longitudinal growth direction. In either case, the pressing can be effective to reduce a thickness of the lignin-compromised fibrous plant material veneer, thereby increasing its density as well as collapsing (at least partially) the natural lumina (e.g., vessels, lumen in each fiber, parenchyma cells, etc.), voids, and/or gaps within the cross-section of the lignin-compromised fibrous plant material veneer. In some embodiments, the pressing can be along a single direction (e.g., along radial direction R), for example, to reduce a thickness of the lignin-compromised fibrous plant material veneer (e.g., at least a 5:2 reduction in dimension as compared to the lignin-compromised fibrous plant material veneer prior to pressing).

In some embodiments, the pressing may be performed without any prior drying of the lignin-compromised fibrous plant material veneer or with the lignin-compromised fibrous plant material veneer retaining at least some water or other fluid therein. The pressing can thus be effective to remove at least some water or other fluid from the lignin-compromised fibrous plant material veneer at the same time as its dimension is reduced and density increased. In some embodiments, a separate drying process can be combined with the pressing process. For example, the lignin-compromised fibrous plant material veneer may initially be pressed to cause densification and remove at least some water or fluid therefrom, followed by a drying process (e.g., air drying) to remove the remaining water or fluid. Alternatively, in some embodiments, the lignin-compromised fibrous plant material veneer may initially be dried to remove at least some water or fluid therefrom (e.g., initial drying in a humidity chamber followed by air drying at room temperature, such that the moisture content of the plant material approaches but remains greater than 15 wt %, for example, 10 wt %), followed by pressing to cause densification (and potentially further removal of water or other fluid, for example, a moisture content less than 10 wt %, such as 3-8 wt %).

In some embodiments, the pressing can encourage hydrogen bond formation between the cellulose-based fibers of the cell walls of the lignin-compromised fibrous plant material veneer, thereby improving mechanical properties of the densified, lignin-compromised fibrous plant material veneer. Moreover, any particles or materials formed on surfaces of the lignin-compromised fibrous plant material veneer or within the lignin-compromised fibrous plant material veneer (e.g., via the internal modification of process block 1014) can be retained after the pressing, with the particles/materials on internal surfaces being embedded within the collapsed lumina and intertwined cell walls.

The pressure and timing of the pressing can be a factor of the size of the lignin-compromised fibrous plant material veneer prior to pressing, the desired size of the lignin-compromised fibrous plant material veneer after pressing, the water or fluid content within the lignin-compromised fibrous plant material veneer (if any), the temperature at which the pressing is performed, relative humidity, the characteristics of material (e.g., infiltrated polymer) from the internal modification (if any), and/or other factors. For example, the lignin-compromised fibrous plant material veneer can be held under pressure for a time period of at least 1 minute to up to several hours (e.g., 1-180 minutes, inclusive). In some embodiments, the lignin-compromised fibrous plant material veneer can be held under pressure for 3-72 hours, inclusive. In some embodiments, the pressing can be performed at a pressure between 0.5 MPa and 20 MPa, inclusive, for example, 5 MPa. In some embodiments, the pressing may be performed without heating (e.g., cold pressing), while in other embodiments the pressing may be performed with heating (e.g., hot pressing). For example, the pressing may be performed at a temperature between 20° C. and 160° C., e.g., greater than or equal to 100° C.

The method 1000 can proceed to optional process block 1018, where the densified, lignin-compromised fibrous plant material veneer may be subject to an external modification. Although the term “external” is used to refer to the modification of process block 1018, it is contemplated that, in some embodiments, the modification may be applied to internal features as well as external features of the densified, lignin-compromised fibrous plant material veneer, while in other embodiments the modification may be applied to either internal features or external features of the densified, lignin-compromised fibrous plant material veneer without otherwise affecting the other feature. In some embodiments, the external modification can include forming, depositing, or otherwise providing a coating on one or more external surfaces of the densified, lignin-compromised fibrous plant material veneer. The coating may imbue the densified, lignin-compromised fibrous plant material veneer with certain advantageous properties, such as but not limited to hydrophobicity, weatherability, corrosion resistance (e.g., salt water resistant), and/or flame resistance. For example, the coating can comprise an oil-based paint, a hydrophobic paint, a polymer coating, and/or a fire-resistant coating. In some embodiments, the fire-resistant coating can include nanoparticles (e.g., boron nitride nanoparticles). Alternatively or additionally, in some embodiments, a coating for the densified, lignin-compromised fibrous plant material veneer can include boron nitride (BN), montmorillonite clay, hydrotalcite, silicon dioxide (SiO₂), sodium silicate, calcium carbonate (CaCO₃), aluminum hydroxide (Al(OH)₃), magnesium hydroxide (Mg(OH)₂), magnesium carbonate (MgCO₃), aluminum sulfate, iron sulfate, zinc borate, boric acid, borax, triphenyl phosphate (TPP), melamine, polyurethane, ammonium polyphosphate, phosphate, phosphite ester, ammonium phosphate, ammonium sulfate, phosphonate, diammonium phosphate (DAP), ammonium dihydrogen phosphate, monoammonium phosphate (MAP), guanylurea phosphate (GUP), guanidine dihydrogen phosphate, antimony pentoxide, or any combination of the above.

In some embodiments, the optional external modification of process block 1018 can include sealing the densified, lignin-compromised fibrous plant material veneer to prevent ingress of moisture or egress of moisture. In some embodiments, the sealing is by placing the veneer in a sealed or controlled environment. Alternatively or additionally, the sealing can be achieved by a protective layer or coating provided over exposed surfaces of the veneer. For example, the protecting layer or coating can be a polyurethane coating, paint, silane hydrophobic coating, or any other coating effective to prevent, or at least restrict, movement of moisture into or out of the fibrous plant material. Alternatively or additionally, the external modification can include a destructive modification, for example, machining or cutting to prepare the densified veneer for subsequent use.

The method 1000 can proceed to process block 1020, where the densified, lignin-compromised fibrous plant material veneer can be wrapped about a central axis to form at circumferentially-extending wall, or at least a part thereof, for example, as described with respect to FIG. 10B. Although blocks 1002-1020 of method 1000 have been described as being performed once, in some embodiments, multiple repetitions of a particular process block may be employed before proceeding to the next decision block or process block. In addition, although blocks 1002-1020 of method 1000 have been separately illustrated and described, in some embodiments, process blocks may be combined and performed together (simultaneously or sequentially). Moreover, although FIG. 10A illustrates a particular order for blocks 1002-1020, embodiments of the disclosed subject matter are not limited thereto. Indeed, in certain embodiments, the blocks may occur in a different order than illustrated or simultaneously with other blocks. In some embodiments, method 1000 may comprise only some of blocks 1002-1020 of FIG. 10A.

Referring to FIG. 10B, a method 1022 for forming a circumferentially-extending wall from one or more densified, lignin-compromised fibrous plant material veneers is shown. The method 1022 can begin at decision block 1024, where the thickness of the veneer is evaluated. If the thickness is less than or equal to 1 mm (or if the veneer is greater than 1 mm in thickness and has been infiltrated with a polymer), the method 1022 can proceed to process block 1026, where a glue can be applied to one or more surfaces (or surface portions) of a densified, lignin-compromised veneer. For example, glue can be evenly coated on a surface of the densified, lignin-compromised veneer prior to rolling around a cylindrical mold to form a hollow tube. In some embodiments, the veneer glued by epoxy can exhibit a shear force of about 5.5 kN. For example, the glue can be epoxy, polyvinyl acetate (PVA), polyurethane, cyanoacrylate, casein, urea-formaldehyde, aliphatic resin, contact cement, resorcinol-formaldehyde, phenol formaldehyde, sodium carboxymethyl cellulose (CMC), hide glue derived from animal collagen, or any combination of the foregoing. The method 1022 can proceed to process block 1028, where the densified, lignin-compromised veneer can be wrapped around a molding axis (e.g., a molding member, a roller, and/or open space) to form a circumferentially-extending layer. In some embodiments, the wrapping can be with the longitudinal growth direction extending parallel to the molding axis (e.g., flat wrap), the longitudinal growth direction being at an angle to the molding axis (e.g., helix wrap), or the longitudinal growth direction extending parallel to a circumferential direction (e.g., hoop wrap).

If the thickness of the veneer is greater than 1 mm (and/or the veneer has not been infiltrated with a polymer), the method 1022 can proceed from decision block 1024 to decision block 1032, where it is determined if a fluid shock treatment should be performed. If it is determined that a fluid shock will not be performed, the method 1022 can proceed from decision block 1032 to process block 1042, where the densified, lignin-compromised veneer can be partially dried. For example, the partial drying of process block 1042 can be such that the densified, lignin-compromised veneer has a moisture content of at least 30 wt % (e.g., ≥50 wt %). Otherwise, if it is determined that a fluid shock will be performed, the method 1022 can proceed from decision block 1032 to process block 1034, where the densified, lignin-compromised veneer is fully dried. For example, the full drying of process block 1034 can be such that the densified, lignin-compromised veneer has a moisture content of 15 wt % or less (e.g., less than ˜8-12 wt %, such as 3-8 wt %, inclusive).

The drying of either process block 1042 or process block 1034 can include any of conductive, convective, and/or radiative heating processes, including but not limited to an air-drying process, a vacuum-assisted drying process, an oven drying process, a freeze-drying process, a critical point drying process, a microwave drying process, or any combination of the above. For example, an air-drying process can include allowing the densified, lignin-compromised veneer material to naturally dry in static or moving air, which air may be at any temperature, such as room temperature (e.g., 23° C.) or at an elevated temperature (e.g., greater than 23° C.). For example, a vacuum-assisted drying process can include subjecting the densified, lignin-compromised veneer to reduced pressure, e.g., less than 1 bar, for example, in a vacuum chamber or vacuum oven. For example, an oven drying process can include using an oven, hot plate, or other conductive, convective, or radiative heating apparatus to heat the densified, lignin-compromised veneer at an elevated temperature (e.g., greater than 23° C.), for example, 70° C. or greater. For example, a freeze-drying process can include reducing a temperature of the densified, lignin-compromised veneer to below a freezing point of the fluid therein (e.g., less than 0° C.), then reducing a pressure to allow the frozen fluid therein to sublime (e.g., less than a few millibars). For example, a critical point drying process can include immersing the densified, lignin-compromised veneer in a fluid (e.g., liquid carbon dioxide), increasing a temperature and pressure of the densified, lignin-compromised veneer past a critical point of the fluid (e.g., 7.39 MPa, 31.1° C. for carbon dioxide), and then gradually releasing the pressure to remove the now gaseous fluid. For example, a microwave drying process can include using a microwave oven or other microwave generating apparatus to induce dielectric heating within the densified, lignin-compromised veneer by exposing it to electromagnetic radiation having a frequency in the microwave regime (e.g., 300 MHz to 300 GHZ), for example, a frequency of ˜915 MHz or ˜2.45 GHZ.

In some embodiments, the full drying of process block 1034 causes shrinkage of the densified, lignin-compromised veneer, which in turn causes significant buckling of the cell walls. In some embodiments, the lumina formed by the longitudinal cells may collapse (e.g., fully collapse such that facing surfaces of the channel walls are in contact, or at least the widths of the channels significantly narrow). After the drying of process block 1034, the method 1022 can proceed to process block 1036, where the densified, lignin-compromised veneer is rehydrated using a fluid shock technique. For example, the densified, lignin-compromised veneer can be partially or fully immersed in a fluid (e.g., water, alcohol, or any combination thereof) for a short period of time (e.g., several minutes, such as 3 minutes or less, for example, on the order of seconds) such that the rehydrated material has a moisture content of at least 30 wt % (e.g., around 50 wt %). Methods for rehydration other than immersion in fluid are also possible according to one or more embodiments. For example, rehydration can be achieved by exposure to a humidified environment.

In some embodiments, the rehydration is effective to re-swell the cells wall and allow larger lumina (e.g., vessels) to re-open while smaller lumina (e.g., fiber cells) to remain substantially collapsed. The swelling introduced by the fluid shock can create wrinkles in the cell wall structure, which can allow the softened fibrous plant material to accommodate severe tension and compression without damage.

With the softened fibrous plant material having a moisture content of at least 30 wt % after either process block 1036 or process block 1042, the method 1022 can proceed to process block 1038 where an aqueous glue can be applied to one or more surfaces (or surface portions) of the densified, lignin-compromised veneer. For example, the glue can be evenly coated on a surface of the densified, lignin-compromised veneer prior to rolling around a cylindrical mold to form a hollow tube. For example, the aqueous glue can be polyvinyl acetate (PVA), sodium carboxymethyl cellulose (CMC), water-based polyurethane, hide glue derived from animal collagen. The method 1022 can proceed to process block 1040, where the densified, lignin-compromised veneer can be wrapped around a molding axis (e.g., either a molding member or open space) to form a circumferentially-extending layer. In some embodiments, the wrapping can be with the longitudinal growth direction extending parallel to the molding axis (e.g., flat wrap), the longitudinal growth direction being at an angle to the molding axis (e.g., helix wrap), or the longitudinal growth direction extending parallel to a circumferential direction (e.g., hoop wrap). During the wrapping of process block 1040, the moisture content of the densified, lignin-compromised veneer can be at least 30 wt % and therefore in a substantially flexible/moldable state. As a result, the veneer can readily adopt the desired circumferentially-extending shape without cracking, despite its thickness being larger than 1 mm.

The method 1022 can proceed from either process block 1028 or process block 1040 to decision block 1030, where it is determined if another layer of veneer is to be added to the circumferentially-extending wall. If additional layers are desired, the method 1022 can return to decision block 1024; otherwise, the method can proceed to decision block 1044, where it is determined if a post-molding modification is desired. In some embodiments, the post-molding modification can include applying varnish, paint, stain, oil, wax, or any combination of the foregoing to one or more surfaces (e.g., interior, exterior, and/or exposed surfaces) of the circumferentially-extending wall. For example, the wrapped layers forming the wall can be scaled to prevent ingress of moisture or egress of moisture and thereby maintaining the molded (e.g., rigid) state of the wall. Alternatively or additionally, the sealing can be achieved by a protective layer or coating provided over exposed surfaces of the fibrous plant material. For example, the protecting layer or coating can be a polyurethane coating, paint, silane hydrophobic coating, or any other coating effective to prevent, or at least restrict, movement of moisture into or out of the fibrous plant material. Alternatively or additionally, the post-molding modification can include a destructive modification, for example, machining or cutting to prepare the lignin-modified fibrous plant material for subsequent use.

In some embodiments, the post-molding modification can include forming a composite structure, in which case, the method can proceed from decision block 1044 to process block 1046. At process block 1046, a non-plant layer can be provided (e.g., deposited, coated, laminated, etc.) over an internal surface of the circumferentially-extending wall and/or another non-plant layer can be provided over an external surface of the circumferentially-extending wall. In some embodiments, the non-plant layer can comprise a metal, polymer, or concrete. If no modification is desired at decision block 1044, or after process block 1046, the method can proceed to process block 1048, where the wall formed by wrapping one or more densified, lignin-compromised fibrous plant material veneers about a central axis can be used in one or more applications, such as but not limited to structural applications, energy absorption (e.g., crush protection for buildings in earthquakes or other natural disasters, vehicle bumpers, airplane ejector seat, etc.), and fluid conveyance. For example, in some embodiments, a tube formed of densified, lignin-compromised wood veneers can have a compressive strength of ˜90 MPa, which is higher than Al alloy tubes.

Although some of blocks 1024-1048 of method 1022 have been described as being performed once, in some embodiments, multiple repetitions of a particular process block may be employed before proceeding to the next decision block or process block. In addition, although blocks 1024-1048 of method 1022 have been separately illustrated and described, in some embodiments, process blocks may be combined and performed together (simultaneously or sequentially). Moreover, although FIG. 10B illustrates a particular order for 1024-1048, embodiments of the disclosed subject matter are not limited thereto. Indeed, in certain embodiments, the blocks may occur in a different order than illustrated or simultaneously with other blocks. In some embodiments, method 1022 may comprise only some of blocks 1024-1048 of FIG. 10B.

### Fabricated Examples and Experimental Results

A natural wood veneer (basswood, typical sample dimensions: 0.5 mm×30 cm×20 cm) was treated with a boiling aqueous solution of 2.5 M NaOH and 0.4 M Na₂SO₃ for 1 hour, followed by immersion in water several times to remove the chemicals. The partial delignification process removed ˜70% of the lignin and ˜85% of the hemicellulose from the wood's lignocellulosic cell walls. Next, the partially-delignified wood veneer was pressed for 5 min at 105° C. under 5 MPa pressure to form the densified, delignified veneer, with the density increasing from 0.4 g/cm³ to 1.3 g/cm³. The tensile strength of the densified, delignified veneer was ˜650 MPa, which is about 10-fold higher than that of natural wood veneer (66 MPa). Note that, the tensile strength of the densified, delignified veneer is tested along the cellulose fiber alignment direction, but the strength in the direction perpendicular to the cellulose fiber alignment direction is much lower (20.5 MPa), due to the anisotropic properties of the wood.

Tubes were achieved by rolling the densified, delignified veneer on a cylindrical mold in the direction of the wood fiber or at an angle and gluing. Epoxy (ClearWeld 5 Minute, J-B Weld) was used to glue the adjacent layers in the tube wall. Three strategies for the wrapping were employed. The first strategy was rolling the densified, delignified veneer on a cylinder mold along the cellulose fiber alignment direction and bonded with epoxy. SEM morphology studies reveal the different super wood veneer layers are tightly glued together, and the fibers are parallel to the axis of the tube, as shown in FIGS. 2E-2F. The second strategy was rolling the densified, delignified veneer on the cylinder mold at a 45° angle, each layer being rolled up at the same angle, as shown in FIGS. 4A-4C. As a result, the cellulose fibers in each layer are parallel at the same angle. In this way, wood tubes of any length could be achieved. The third strategy was to roll up the densified, delignified veneer on the mold in a cross helix wrapping. Specifically, if the super wood veneer on the first layer is rolled up in a left helix at a 45° angle, the next layer is rolled up in the opposite direction (right helix) at the same angle and repeats until the target wall thickness is reached, as shown in FIGS. 4D-4F. Thus, the cellulose fibers in different layers present the same angle to the tube axis but opposite wrap up directions.

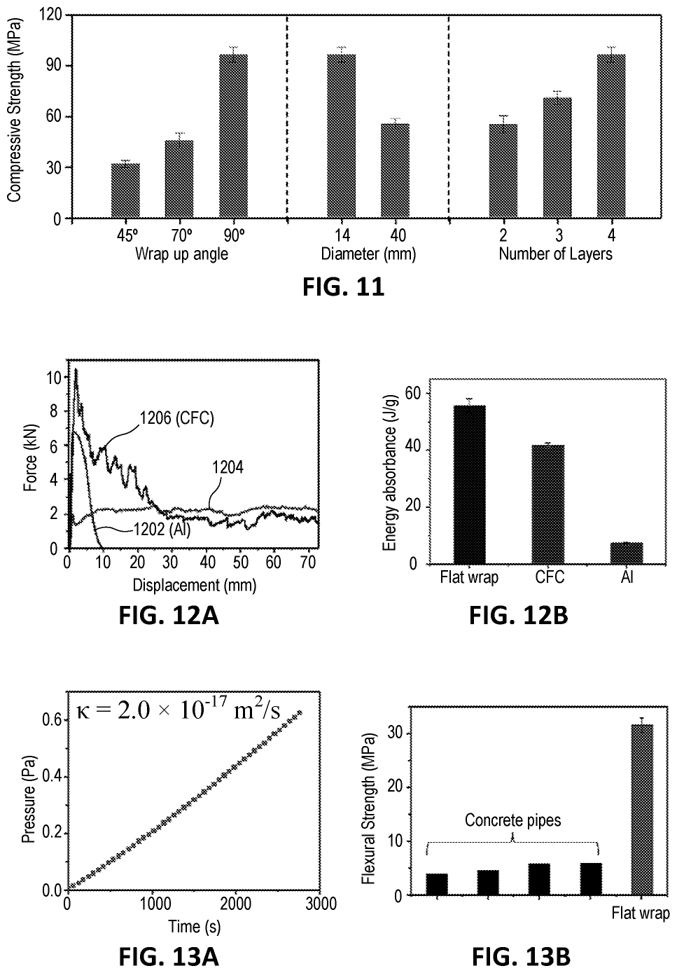

The compressive strength of the resulting tubes can depend on various parameters of the tube structure, including the diameter, wall thickness, twisting direction, etc. As shown in FIG. 11, tubes with an inner diameter of 14 mm show a higher compressive strength than tubes with an inner diameter of 40 mm. With the wrap up angle increasing from 45° to 90° during preparation of the tubes, the compressive strength increases. In addition, the compressive strength increases with the increase of the wall thickness, as shown in FIG. 11. This indicates that the mechanical deformation of circumferentially-extending wood wall can be a multiscale behavior, which depends on the raw materials (e.g., wood species), wood veneer (e.g., thickness, cutting direction), chemical treatment (e.g., lignin vs. cellulose fibers), tube (e.g., diameter, wrapping direction, veneer layer number, and glues between layers).

Tubes prepared by cross-helix wrapping (fiber direction is 45° away from the tube axial direction) also show petaling failure under compressive loading but in a more complicated manner. Under axial compression, the tube prepared by cross helix wrapping first fracture in multiple locations at the end along the cellulose fiber direction due to the anisotropic nature of the densified, delignified wood veneer. Further, compressive loading drives the splitting of the tube along 45°. After splitting, the strips curl into a helix form and stick out in a radial direction. However, the tubes prepared by wrapping up at a 45° angle did not exhibit a petaling failure mode. Instead, the glue between the two layers of wrapped veneers is torn apart.

The unique failure mode of the densified, delignified wood veneer tube leads to a drastic increase in energy absorption during the fracture process, compared with the failure of an isotropic aluminum tube. FIG. 12A plots the force-displacement curves of the flat wrapping tube 1204, the aluminum tube 1202, and the carbon fiber cloth tube 1206 under axial compression test. The compressive failure of the aluminum tube features a sharp peak in the compressive force at a rather small displacement, which corresponds to the onset of the buckling of the tube; followed by an abrupt drop of the force to zero, indicating the loss of structural integrity once the deformation is localized at the buckled region and leads to the failure of the aluminum tube. In contrast, the force-displacement curve of the flat wrapping tube 1204 peaks at a small displacement (corresponding to the onset of petaling) but then drops to a modest level and remains rather constant over a large displacement until the end of the test. The force-displacement curve of the carbon fiber cloth tube 1206 shows a similar trend but with a drastic drop in force after the peak. The area underneath the force-displacement curve measures the energy absorbed by the failure process of the tubes. The tube prepared by flat wrapping exhibits a compelling high specific energy absorption 54.22±2.18 J/g, which is 7.3 times, 1.3 times, and 1.5 times higher than that of aluminum tubes (7.41±0.38 J/g), carbon fiber tubes (41.80±0.83 J/g), and cross helix wrapping tubes (20.68±1.71 J/g).

To further explore the energy dissipation performance of wood tubes under different circumstances, static tests (the axial compression tests) and dynamic tests (the drop tower tests) were performed to investigate failure behaviors and how much energy is absorbed by the tubes. Two flat wrapping tubes with different geometric dimensions were used in static tests, i.e., 40 mm×0.75 mm×100 mm and 14 mm×0.75 mm×100 mm (inner diameter×wall thickness×length). The inner diameter of the 40 mm sample shows a typical local buckling failure, which is similar to the failure mode of aluminum alloy tubes. However, the inner diameter of the 14 mm sample presents a sunflower petal-like failure mode which can be hardly seen on other types of commercially-available tubes. The wood tube is cracked gradually by splitting its thin, circular wall into several petals and the petals curl themselves during the test. Due to the considerable amount of energy dissipation during the wall splitting in the petal-like mode, the effective energy absorption under static compression load of the petal-like failure sample (55.3 J/g) is ˜150 times higher than that of local buckling sample (0.37 J/g).

Aiming to increase the energy dissipation of the inner diameter of the 40 mm wood tube, pre-cuts were applied on one end of the tube. Cracks initiated from these pre-cuts and then propagated along the axial direction as the compressing cap displaces further. The effective energy absorption of the pre-cuts sample is 13.32 J/g. 36 times higher than that of sample without pre-cuts (computed from the area under the force-displacement curve in FIG. S19).

In order to test the wood tubes dynamically, a drop tower was used. The tube was preloaded by the self-weight of a steel plate. A steel ball was dropped from a certain height and hit the center of the steel plate, which then impacts the wood tube dynamically. Due to the petal-like failure mode, the effective energy absorption in a dynamic impact test of the sample was 48.34 J/g, comparable to that of in a static test (55.3 J/g). Thus, the wood tubes exhibit remarkable energy absorption performance under both static and dynamic loadings.

Furthermore, three consecutive impact tests were carried out for the same three wood tubes. After the first impact test, the tube starts to petal at the end in contact with the bottom end cap. After the second impact test, the petaling at the bottom end of the tube advances further and the top end of the tube starts to petal too. After the third impact test, the petaling at both ends further advances. The wood tubes can absorb dynamic impact energy at a level comparable to the wood tube under static compression loading. Moreover, the wood tubes retain structural integrity even after they are partially fractured by petaling. The unfractured portion of the wood tubes can continue absorbing dynamic impact energy in subsequent tests—a unique and desirable feature that suggests their potential application as a highly effective structural component for energy absorption, especially during dynamic impacts.

In addition to impressive energy absorbance, the wood tubes also exhibit good thermal conductivity, which suggests that the wood tubes can be used in construction. For example, the super wood tubes can replace the aluminum alloy tubes for the curtain wall door framing. The disclosed wood engineering process also applies to the fabrication of pipes, and the wood pipes exhibit good gas barrier properties due to the dense structure of the densified, lignin-compromised wood veneer. As suggested by FIG. 13A, the permeability of the wood pipe is 2.0×10⁻¹⁷ m²/s, which is lower than that of most of the polymers and comparable with steel pipe. As such, the wood pipes would be suitable for oil and gas (e.g., H₂ and natural gas) transportation, but without H₂ embrittlement problems.

The disclosed techniques also allow preparation of long tubes for, for example, curtain walls with low thermal conductivity to replace aluminum tubes, pipes with low permeability that can be used for gas transport (e.g., H₂, natural gas) but without H₂ embrittlement problems, and pipes with good flexural strength to replace concrete pipes. In a fabricated example, a wood pipe was constructed with a diameter of 16 cm. The wood pipe exhibited a flexural strength of 30.5 MPa, which is about 5 times higher than that of concrete pipes, as shown in FIG. 13B.

In addition to tubes and pipes, wood rods were also fabricated by cross helix wrapping densified, delignified wood veneers on a natural wood core at a 45° angle, which can improve the impact properties of the resulting product, as shown in FIG. 9E. A baseball bat was also fabricated with a diameter of 5 cm by rolling 90 layers of densified, delignified wood veneers on a natural wood rod, as shown in FIG. 9F.

### Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. A structure comprising:
one or more densified, lignin-compromised fibrous plant material veneers wrapped around a central axis, so as to form a circumferentially-extending fibrous plant material wall.

Clause 2. The structure of any clause or example herein, in particular, Clause 1, wherein a glue is provided on one or more surface portions of each fibrous plant material veneer.

Clause 3. The structure of any clause or example herein, in particular, Clause 2, wherein the glue comprises epoxy, polyvinyl acetate (PVA), polyurethane, sodium carboxymethyl cellulose (CMC), cyanoacrylate, casein, urea-formaldehyde, aliphatic resin, contact cement, resorcinol-formaldehyde, phenol formaldehyde, hide glue derived from animal collagen, or any combination of the foregoing.

Clause 4. The structure of any clause or example herein, in particular, any one of Clauses 2-3, wherein the circumferentially-extending fibrous plant material wall consists essentially of the one or more densified, lignin-compromised fibrous plant material veneers and the glue.

Clause 5. The structure of any clause or example herein, in particular, any one of Clauses 1-4, wherein the circumferentially-extending fibrous plant material wall exhibits a compressive strength of 50-90 MPa along a direction substantially parallel to the central axis.

Clause 6. The structure of any clause or example herein, in particular, any one of Clauses 1-5, wherein each densified, lignin-compromised fibrous plant material veneer comprises cellulose nanofibers forming walls of collapsed longitudinal fibrous plant material cells, and the cellulose nanofibers are substantially aligned with a longitudinal growth direction of the fibrous plant material.

Clause 7. The structure of any clause or example herein, in particular, any one of Clauses 1-6, wherein each densified, lignin-compromised fibrous plant material veneer has a tensile strength along its longitudinal growth direction of at least 400 MPa.

Clause 8. The structure of any clause or example herein, in particular, any one of Clauses 1-7, wherein the longitudinal growth direction of at least one of the one or more densified, lignin-compromised fibrous plant material veneers is substantially parallel to the central axis.

Clause 9. The structure of any clause or example herein, in particular, any one of Clauses 1-8, wherein the longitudinal growth direction of at least one of the one or more densified, lignin-compromised fibrous plant material veneers is substantially perpendicular to a plane containing the central axis.

Clause 10. The structure of any clause or example herein, in particular, any one of Clauses 1-9, wherein the longitudinal growth direction of at least one of the one or more densified, lignin-compromised fibrous plant material veneers is at a non-zero angle with respect to the central axis.

Clause 11. The structure of any clause or example herein, in particular, Clause 10, wherein the non-zero angle between the longitudinal growth direction and the central axis is in a range of 10°-80°, inclusive.

Clause 12. The structure of any clause or example herein, in particular, any one of Clauses 10-11, wherein the non-zero angle between the longitudinal growth direction and the central axis is about 45°.

Clause 13. The structure of any clause or example herein, in particular, any one of Clauses 10-12, wherein an orientation of the longitudinal growth direction of a first of the one or more densified, lignin-compromised fibrous plant material veneers crosses an orientation of the longitudinal growth direction of a second of the one or more densified, lignin-compromised fibrous plant material veneers.

Clause 14. The structure of any clause or example herein, in particular, Clause 13, wherein the longitudinal growth directions of the first and second of the one or more densified, lignin-compromised fibrous plant material veneers cross at a substantially 90° angle.

Clause 15. The structure of any clause or example herein, in particular, any one of Clauses 1-14, wherein at least one of the one or more densified, lignin-compromised fibrous plant material veneers has a density of at least 1 g/cm³, or at least 1.15 g/cm³.

Clause 16. The structure of any clause or example herein, in particular, any one of Clauses 1-15, wherein at least one of the one or more densified, lignin-compromised fibrous plant material veneers has a density of about 1.3 g/cm³, or in a range of 1.3-1.5 g/cm³, inclusive.

Clause 17. The structure of any clause or example herein, in particular, any one of Clauses 1-16, wherein an inner diameter of the circumferentially-extending fibrous plant material wall is at least 5 mm, at least 1 cm, or at least 10 cm.

Clause 18. The structure of any clause or example herein, in particular, any one of Clauses 1-17, wherein a length of the circumferentially-extending fibrous plant material wall along an axis thereof is at least 1 cm, at least 10 cm, or at least 1 m.

Clause 19. The structure of any clause or example herein, in particular, any one of Clauses 1-18, wherein the circumferentially-extending fibrous plant material wall exhibits a specific energy absorption of at least 45 J/g under compression along a direction substantially parallel to the central axis.

Clause 20. The structure of any clause or example herein, in particular, any one of Clauses 1-19, wherein a cross-sectional shape of the circumferentially-extending fibrous plant material wall is a circle, a triangle, or a rectangle.

Clause 21. The structure of any clause or example herein, in particular, any one of Clauses 1-20, wherein the structure forms a hollow member that is open at both axial ends.

Clause 22. The structure of any clause or example herein, in particular, any one of Clauses 1-21, wherein the hollow member is a tube or pipe.

Clause 23. The structure of any clause or example herein, in particular, any one of Clauses 1-20, wherein:
the circumferentially-extending fibrous plant material wall forms a hollow member that is open at one axial end; and
the structure further comprises one or more second members closing an opposite axial end of the hollow member.

Clause 24. The structure of any clause or example herein, in particular, Clause 23, wherein the one or more second members are formed of natural fibrous plant material, metal, polymer, cork, cement, densified fibrous plant material, or densified lignin-comprised fibrous plant material.

Clause 25. The structure of any clause or example herein, in particular, any one of Clauses 23-24, wherein the structure forms a closed-end tube, cup, tank, or bottle.

Clause 26. The structure of any clause or example herein, in particular, any one of Clauses 1-20, further comprising one or more central members around which the circumferentially-extending fibrous plant material wall is wrapped.

Clause 27. The structure of any clause or example herein, in particular, Clause 26, where the one or more central members comprise a natural fibrous plant material rod, a metal rod, a polymer rod, a cork rod, a densified fibrous plant material rod, a lignin-compromised fibrous plant material rod, a densified lignin-compromised fibrous plant material rod, or any combination of the foregoing.

Clause 28. The structure of any clause or example herein, in particular, any one of Clauses 26-27, wherein the structure forms a rod, a bat, a club, or a dowel rod.

Clause 29. The structure of any clause or example herein, in particular, any one of Clauses 1-22, further comprising:
(a) one or more first non-plant layers disposed over an interior surface portion of the circumferentially-extending fibrous plant material wall;
(b) one or more second non-plant layers disposed over an exterior surface portion of the circumferentially-extending fibrous plant material wall; or both (a) and (b).

Clause 30. The structure of any clause or example herein, in particular, any one of Clauses 29, wherein one, some, or all of the non-plant layers comprises metal, polymer, or concrete.

Clause 31. The structure of any clause or example herein, in particular, any one of Clauses 29-30, wherein:
a total thickness of the one or more first non-plant layers is less than or equal to 50% of a total thickness of the circumferentially-extending fibrous plant material wall along a radial direction of the fibrous plant material wall; and/or
a total thickness of the one or more second non-plant layers is less than or equal to 50% of a total thickness of the circumferentially-extending fibrous plant material wall along a radial direction of the fibrous plant material wall.

Clause 32. The structure of any clause or example herein, in particular, any one of Clauses 1-31, wherein one, some, or all of the one or more densified, lignin-compromised fibrous plant material veneers comprises modified lignin therein, and the modified lignin has shorter macromolecular chains than that of native lignin in natural fibrous plant material.

Clause 33. The structure of any clause or example herein, in particular, any one of Clauses 1-32, wherein a content of the modified lignin in one, some, or all of the one or more densified, lignin-compromised fibrous plant material veneers is at least 90% of a content of the native lignin in the natural fibrous plant material.

Clause 34. The structure of any clause or example herein, in particular, any one of Clauses 1-33, wherein a content of the modified lignin in one, some, or all of the one or more densified, lignin-compromised fibrous plant material veneers is at least 20 wt %.

Clause 35. The structure of any clause or example herein, in particular, any one of Clauses 1-34, wherein one, some, or all of the one or more densified, lignin-compromised fibrous plant material veneers comprises a salt of an alkaline chemical immobilized within a cellulose-based microstructure.

Clause 36. The structure of any clause or example herein, in particular, Clause 35, wherein the salt is substantially pH-neutral.

Clause 37. The structure of any clause or example herein, in particular, any one of Clauses 1-31, wherein one, some, or all of the one or more densified, lignin-compromised fibrous plant material veneers comprises at least partially delignified fibrous plant material.

Clause 38. The structure of any clause or example herein, in particular, Clause 37, wherein a lignin content of the at least partially delignified fibrous plant material is between 10% and 99%, inclusive, of a lignin content of natural fibrous plant material.

Clause 39. The structure of any clause or example herein, in particular, any one of Clauses 37-38, wherein:
the at least partially delignified fibrous plant material is a hardwood or bamboo, and a lignin content of the at least partially delignified fibrous plant material is between 1.8 wt % and 24.8 wt %, inclusive; or
the at least partially delignified fibrous plant material is a softwood, and a lignin content of the at least partially delignified fibrous plant material is between 2.5 wt % and 34.7 wt %, inclusive.

Clause 40. The structure of any clause or example herein, in particular, any one of Clauses 37-38, wherein a lignin content of the at least partially delignified fibrous plant material is less than or equal to 10 wt %.

Clause 41. The structure of any clause or example herein, in particular, any one of Clauses 37-38, wherein a lignin content of the at least partially delignified fibrous plant material is less than 10% of a lignin content of natural fibrous plant material.

Clause 42. The structure of any clause or example herein, in particular, any one of Clauses 37-38, wherein:
the at least partially delignified fibrous plant material is a hardwood or bamboo, and a lignin content of the at least partially delignified fibrous plant material is less than 2.5 wt %; or
the at least partially delignified fibrous plant material is a softwood, and a lignin content of the at least partially delignified fibrous plant material is less than 3.5 wt %.

Clause 43. The structure of any clause or example herein, in particular, any one of Clauses 1-42, wherein one, some, or all of the densified, lignin-compromised fibrous plant material veneers have a thickness along a radial direction of the circumferentially-extending fibrous plant material wall that is less than or equal to 3 mm.

Clause 44. The structure of any clause or example herein, in particular, any one of Clauses 1-43, wherein one, some, or all of the densified, lignin-compromised fibrous plant material veneers have a thickness along a radial direction of the circumferentially-extending fibrous plant material wall that is less than or equal to 300 μm.

Clause 45. The structure of any clause or example herein, in particular, any one of Clauses 1-44, wherein one, some, or all of the densified, lignin-compromised fibrous plant material veneers have a thickness along a radial direction of the circumferentially-extending fibrous plant material wall in a range of 100-250 μm, inclusive.

Clause 46. The structure of any clause or example herein, in particular, any one of Clauses 1, further comprising a protective layer or coating formed over one or more surfaces of the circumferentially-extending fibrous plant material wall.

Clause 47. The structure of any clause or example herein, in particular, any one of Clauses 1-46, wherein one, some, or all of the one or more densified, lignin-compromised fibrous plant material veneers have been compressed in a direction substantially perpendicular to a longitudinal growth direction of the fibrous plant material, such that lumina formed by cellulose-based cell walls in a microstructure of the fibrous plant material are substantially collapsed.

Clause 48. The structure of any clause or example herein, in particular, any one of Clauses 1-47, wherein one, some, or all of the one or more densified, lignin-compromised fibrous plant material veneers have a moisture content less than or equal to 15 wt %.

Clause 49. The structure of any clause or example herein, in particular, any one of Clauses 1-48, wherein a length of the circumferentially-extending fibrous plant material wall along a direction parallel to the central axis is at least ten times a thickness of the circumferentially-extending fibrous plant material wall along a direction perpendicular to the central axis.

Clause 50. The structure of any clause or example herein, in particular, any one of Clauses 1-49, wherein the fibrous plant material is a hardwood, a softwood, or bamboo.

Clause 51. An energy absorbing system comprising:
a plurality of the structures, each structure being according to any clause or example herein, in particular, any one of Clauses 1-50.

Clause 52. The energy absorbing system of any clause or example herein, in particular, Clause 51, further comprising:
a pair of support members, the plurality of structures being sandwiched between the pair of support members.

Clause 53. The energy absorbing system of any clause or example herein, in particular, Clause 52, wherein the support members are formed of natural fibrous plant material, metal, polymer, concrete, densified fibrous plant material, or densified lignin-compromised fibrous plant material.

Clause 54. The energy absorbing system of any clause or example herein, in particular, any one of Clauses 52-53, wherein the central axis of each structure is substantially perpendicular to a respective facing surface portion of each support member.

Clause 55. The energy absorbing system of any clause or example herein, in particular, any one of Clauses 52-53, wherein the central axis of each structure is substantially parallel to the central axes of the other structures of the plurality of the structures.

Clause 56. The energy absorbing system of any clause or example herein, in particular, any one of Clauses 51-55, wherein each structure further comprises an end cap coupled to a respective axial end of the circumferentially-extending fibrous plant material wall, the end cap being in contact with a facing surface portion of the respective support member.

Clause 57. The energy absorbing system of any clause or example herein, in particular, any one of Clauses 51-56, wherein at least a portion of one, some, or all of the plurality of structures is hollow.

Clause 58. A method comprising:
(a) subjecting one or more natural fibrous plant material veneers to one or more chemical treatments, so as to form one or more lignin-compromised veneers;
(b) after (a), compressing the one or more lignin-compromised veneers along a direction crossing a longitudinal growth direction of the fibrous plant material, so as to form one or more densified, lignin-compromised veneers; and
(c) after (b), wrapping the one or more densified, lignin-compromised veneers around a central axis, so as to form a circumferentially-extending fibrous plant material wall.

Clause 59. The method of any clause or example herein, in particular, Clause 58, further comprising, after (b) and prior to (c), providing a glue on one or more surface portions of one, some, or all of the one or more densified, lignin-compromised veneer.

Clause 60. The method of any clause or example herein, in particular, Clause 59, wherein the glue comprises epoxy, polyvinyl acetate (PVA), polyurethane, sodium carboxymethyl cellulose (CMC), cyanoacrylate, casein, urea-formaldehyde, aliphatic resin, contact cement, resorcinol-formaldehyde, phenol formaldehyde, hide glue derived from animal collagen, or any combination of the foregoing.

Clause 61. The method of any clause or example herein, in particular, any one of Clauses 58-60, wherein, after (b), each densified, lignin-compromised fibrous plant material veneer comprises cellulose nanofibers forming walls of collapsed longitudinal fibrous plant material cells, and the cellulose nanofibers are substantially aligned with a longitudinal growth direction of the fibrous plant material.

Clause 62. The method of any clause or example herein, in particular, any one of Clauses 58-61, wherein the wrapping of (c) is such that the longitudinal growth direction of at least one of the one or more densified, lignin-compromised fibrous plant material veneers is substantially parallel to the central axis.

Clause 63. The method of any clause or example herein, in particular, any one of Clauses 58-62, wherein the wrapping of (c) is such that the longitudinal growth direction of at least one of the one or more densified, lignin-compromised fibrous plant material veneer is at a non-zero angle with respect to the central axis.

Clause 64. The method of any clause or example herein, in particular, Clause 63, wherein the non-zero angle between the longitudinal growth direction and the central axis is in a range of 10°-80°, inclusive.

Clause 65. The method of any clause or example herein, in particular, any one of Clauses 63-64, wherein the non-zero angle between the longitudinal growth direction and the central axis is about 45°.

Clause 66. The method of any clause or example herein, in particular, any one of Clauses 58-65, wherein the wrapping of (c) is such that an orientation of the longitudinal growth direction of a first of the one or more densified, lignin-compromised fibrous plant material veneers crosses an orientation of the longitudinal growth direction of a second of the one or more densified, lignin-compromised fibrous plant material veneers.

Clause 67. The method of any clause or example herein, in particular, any one of Clauses 58-66, wherein the wrapping of (c) is such that the longitudinal growth directions of the first and second of the one or more densified, lignin-compromised fibrous plant material veneers cross at a substantially 90° angle.

Clause 68. The method of any clause or example herein, in particular, any one of Clauses 58-67, wherein the wrapping of (c) comprises:
(c1) disposing the one or more densified, lignin-compromised fibrous plant material veneers over a mold; and
(c2) after a first time, removing the mold from the one or more densified, lignin-compromised fibrous plant material veneers, such that at least a portion of the circumferentially-extending fibrous plant material wall is hollow.

Clause 69. The method of any clause or example herein, in particular, Clause 68, wherein the mold has a circular, triangular, or rectangular cross-section.

Clause 70. The method of any clause or example herein, in particular, any one of Clauses 58-69, wherein:
the wrapping of (c) comprises disposing the one or more densified, lignin-compromised fibrous plant material veneers over one or more first non-plant layers, and
after (c), the one or more first non-plant layers are retained over an interior surface portion of the circumferentially-extending fibrous plant material wall.

Clause 71. The method of any clause or example herein, in particular, any one of Clauses 58-70, further comprising:
(d) after (c), disposing one or more first non-plant layers over an interior surface portion of the circumferentially-extending fibrous plant material wall;
(e) after (c), disposing one or more second non-plant layers over an exterior surface portion of the circumferentially-extending fibrous plant material wall; or both (d) and (e).

Clause 72. The method of any clause or example herein, in particular, any one of Clauses 70-71, wherein one, some, or all of the non-plant layers comprise metal, polymer, or concrete.

Clause 73. The method of any clause or example herein, in particular, any one of Clauses 58-72, wherein the subjecting of (a) comprises:
(a1) infiltrating the one or more natural fibrous plant material veneers with one or more chemical solutions;
(a2) after (a1), subjecting the one or more natural fibrous plant material veneers with one or more chemical solutions therein to a first temperature of at least 80° C. for a first time, so as to form the one or more lignin-compromised veneers,
wherein, after (c), lignin retained in the one or more lignin-compromised veneers has shorter macromolecular chains than that of native lignin in the one or more natural fibrous plant material veneers prior to (a).

Clause 74. The method of any clause or example herein, in particular, Clause 73, wherein, after (c), each lignin-compromised veneer comprises a pH-neutral salt of the one or more chemical solutions immobilized within a substantially collapsed cellulose-based microstructure of the veneer.

Clause 75. The method of any clause or example herein, in particular, any one of Clauses 73-74, wherein the salt is formed by reaction of the one or more chemical solutions with an acidic degradation product of native hemicellulose in the one or more natural fibrous plant material veneers produced by the one or more chemical solutions during (a2).

Clause 76. The method of any clause or example herein, in particular, any one of Clauses 73-75, wherein the one or more chemical solutions comprise an alkaline solution.

Clause 77. The method of any clause or example herein, in particular, any one of Clauses 73-76, wherein the one or more chemical solutions comprise p-toluenesulfonic acid, NaOH, NaOH+Na₂SO₃/Na₂SO₄, NaOH+Na₂S, NaHSO₃+SO₂+H₂O, NaHSO₃+Na₂SO₃, NaOH+Na₂SO₃, NaOH/NaH₂O₃+AQ, NaOH/Na₂S+AQ, NaOH+Na₂SO₃+AQ, Na₂SO₃+NaOH+CH₃OH+AQ, NaHSO₃+SO₂+AQ. NaOH+Na₂Sx, where AQ is Anthraquinone, any of the foregoing with NaOH replaced by LiOH or KOH, or any combination of the foregoing.

Clause 78. The method of any clause or example herein, in particular, any one of Clauses 73-77, wherein the first temperature is in a range of 120-160° C., inclusive.

Clause 79. The method of any clause or example herein, in particular, any one of Clauses 73-78, wherein the first time is in a range of 1-5 hours, inclusive.

Clause 80. The method of any clause or example herein, in particular, any one of Clauses 73-79, wherein at least 90% of the one or more chemical solutions infiltrated into the one or more natural fibrous plant material veneers is consumed during (a2).

Clause 81. The method of any clause or example herein, in particular, any one of Clauses 73-80, wherein the subjecting to the first temperature of (a2) comprises using steam to heat the one or more natural fibrous plant material veneers with the one or more chemical solutions therein.

Clause 82. The method of any clause or example herein, in particular, any one of Clauses 58-72, wherein the subjecting to one or more chemical treatments of (a) comprises partial or full immersion in one or more chemical solutions at a second temperature for a second time, so as to remove at least some lignin from the one or more natural fibrous plant material veneers.

Clause 83. The method of any clause or example herein, in particular, Clause 82, wherein the one or more chemical solutions comprise an alkaline solution.

Clause 84. The method of any clause or example herein, in particular, any one of Clauses 82-83, wherein the one or more chemical solutions comprise sodium hydroxide (NaOH), lithium hydroxide (LiOH), potassium hydroxide (KOH), sodium sulfite (Na₂SO₃), sodium sulfate (Na₂SO₄), sodium sulfide (Na₂S), NaₙS wherein n is an integer, urea (CH₄N₂O), sodium bisulfite (NaHSO₃), NaH₂O₃, sulfur dioxide (SO₂), anthraquinone (C₁₄H₈O₂), methanol (CH₃OH), ethanol (C₂H₅OH), butanol (C₄H₉OH), formic acid (CH₂O₂), hydrogen peroxide (H₂O₂), acetic acid (CH₃COOH), butyric acid (C₄H₈O₂), peroxyformic acid (CH₂O₃), peroxyacetic acid (C₂H₄O₃), ammonia (NH₃), tosylic acid (p-TsOH), sodium hypochlorite (NaClO), sodium chlorite (NaClO₂), chlorine dioxide (ClO₂), chlorine (Cl₂), water (H₂O) or any combination of the above.

Clause 85. The method of any clause or example herein, in particular, any one of Clauses 82-84, wherein the one or more chemical solutions comprise a boiling solution of NaOH and Na₂SO₃.

Clause 86. The method of any clause or example herein, in particular, any one of Clauses 82-85, wherein:
(i) the second temperature is in a range of 100-160° C., inclusive;
(ii) the second time is in a range of 0.1-96 hours, inclusive; or both (i) and (ii).

Clause 87. The method of any clause or example herein, in particular, any one of Clauses 82-86, wherein the subjecting to one or more chemical treatments of (a) removes between 1% and 90%, inclusive, of native lignin in the one or more natural fibrous plant material veneers to form the one or more lignin-compromised fibrous plant material veneers.

Clause 88. The method of any clause or example herein, in particular, any one of Clauses 82-86, wherein the subjecting to one or more chemical treatments of (a) removes more than 90% of native lignin in the one or more natural fibrous plant material veneers to form the one or more lignin-compromised fibrous plant material veneers.

Clause 89. The method of any clause or example herein, in particular, any one of Clauses 58-88, wherein the one or more natural fibrous plant material veneers have a first thickness along a direction substantially perpendicular to the longitudinal growth direction, the one or more densified, lignin-compromised veneers have a second thickness along the direction substantially perpendicular to the longitudinal growth direction, and the first thickness is at least two times the second thickness.

Clause 90. The method of any clause or example herein, in particular, any one of Clause 89, wherein the first thickness is in a range of 0.02 mm to 1.5 mm, inclusive, and/or the second thickness is less than or equal to 300 μm.

Clause 91. The method of any clause or example herein, in particular, any one of Clauses 58-90, wherein the compressing of (b) comprises pressing the one or more lignin-compromised fibrous plant material veneers at a first pressure of at least 5 MPa for a pressing time.

Clause 92. The method of any clause or example herein, in particular, Clause 91, wherein:
the first pressure is in a range of 5-20 MPa, inclusive;
the pressing time is at least 5 minutes; or
both of the above.

Clause 93. The method of any clause or example herein, in particular, any one of Clauses 58-92, wherein the compressing of (b) comprises pressing the one or more lignin-compromised fibrous plant material veneers while subjecting to a pressing temperature of at least 80° C.

Clause 94. The method of any clause or example herein, in particular, any one of Clauses 58-93, wherein:
during (c), the one or more densified, lignin-compromised veneers have a water content in a range of 30-40 wt %, inclusive, and
the method further comprises, after (c), drying the one or more densified, lignin-compromised veneers to have a water content less than or equal to 15 wt %.

Clause 95. The method of any clause or example herein, in particular, Clause 94, wherein, during (c), a thickness of the one or more densified, lignin-compromised veneers is in a range of 1-3 mm, inclusive.

Clause 96. The method of any clause or example herein, in particular, any one of Clauses 58-93, wherein, during (c), a water content of the one or more densified, lignin-compromised veneers is less than or equal to 15 wt %.

Clause 97. The method of any clause or example herein, in particular, Clause 96, wherein, during (c), a thickness of the one or more densified, lignin-compromised veneers is less than 1 mm.

Clause 98. The method of any clause or example herein, in particular, any one of Clauses 58-97, further comprising, prior to (a), cutting a substantially-cylindrical portion of natural fibrous plant material using a roll-cutting technique to form the one or more natural fibrous plant material veneers.

Clause 99. The method of any clause or example herein, in particular, any one of Clauses 58-98, further comprising, after (c):
subjecting the circumferentially-extending fibrous plant material wall to an axial load,
wherein the subjecting is such that one or both axial ends of the circumferentially-extending fibrous plant material wall exhibits a petal-type failure mode.

Clause 100. The method of any clause or example herein, in particular, any one of Clauses 58-99, further comprising, after (c), using the circumferentially-extending fibrous plant material wall as a fluid-conveying tube or pipe.

Clause 101. The method of any clause or example herein, in particular, any one of Clauses 58-100, further comprising, after (c), using the circumferentially-extending fibrous plant material wall as a thermally-insulating structural material.

Clause 102. The method of any clause or example herein, in particular, any one of Clauses 58-101, wherein the fibrous plant material is a hardwood, a softwood, or bamboo.

### CONCLUSION

Any of the features illustrated or described herein, for example, with respect to FIGS. 1A-13B and Clauses 1-102, can be combined with any other feature illustrated or described herein, for example, with respect to FIGS. 1A-13B and Clauses 1-102 to provide materials, systems, devices, structures, methods, and embodiments not otherwise illustrated or specifically described herein. All features described herein are independent of one another and, except where structurally impossible, can be used in combination with any other feature described herein. In view of the many possible embodiments to which the principles of the disclosed technology may be applied, it should be recognized that the illustrated embodiments are only examples and should not be taken as limiting the scope of the disclosed technology. Rather, the scope is defined by the following claims. We, therefore, claim all that comes within the scope and spirit of these claims.

1. A structure comprising:
one or more densified, lignin-compromised wood veneers wrapped around a central axis, so as to form a circumferentially-extending wood wall.

2. The structure of claim 1, wherein a glue is provided on one or more surface portions of each wood veneer.

3-5. (canceled)

6. The structure of claim 1, wherein each densified, lignin-compromised wood veneer comprises cellulose nanofibers forming walls of collapsed longitudinal wood cells, and the cellulose nanofibers are substantially aligned with a longitudinal growth direction of the wood.

7-9. (canceled)

10. The structure of claim 6, wherein the longitudinal growth direction of each densified, lignin-compromised wood veneer is at a non-zero angle with respect to the central axis.

11-12. (canceled)

13. The structure of claim 10, wherein an orientation of the longitudinal growth direction of a first of the one or more densified, lignin-compromised wood veneers crosses an orientation of the longitudinal growth direction of a second of the one or more densified, lignin-compromised wood veneers.

14. (canceled)

15. The structure of claim 1, wherein at least one of the one or more densified, lignin-compromised wood veneers has a density of at least 1 g/cm³.

16-18. (canceled)

19. The structure of claim 1, wherein the circumferentially-extending wood wall exhibits a specific energy absorption of at least 45 J/g under compression along a direction substantially parallel to the central axis.

20. (canceled)

21. The structure of claim 1, wherein the structure forms a hollow member that is open at both axial ends.

22-28. (canceled)

29. The structure of claim 1, further comprising:
(a) one or more first non-wood layers disposed over an interior surface portion of the circumferentially-extending wood wall;
(b) one or more second non-wood layers disposed over an exterior surface portion of the circumferentially-extending wood wall; or
both (a) and (b).

30-31. (canceled)

32. The structure of claim 1, wherein one, some, or all of the one or more densified, lignin-compromised wood veneers comprises modified lignin therein, and the modified lignin has shorter macromolecular chains than that of native lignin in natural wood.

33. (canceled)

34. The structure of claim 32, wherein a content of the modified lignin in one, some, or all of the one or more densified, lignin-compromised wood veneers is at least 20 wt %.

35-36. (canceled)

37. The structure of claim 1, wherein one, some, or all of the one or more densified, lignin-compromised wood veneers comprises at least partially delignified wood.

38-39. (canceled)

40. The structure of claim 37, wherein a lignin content of the at least partially delignified wood is less than or equal to 10 wt %.

41-56. (canceled)

57. A method comprising:
(a) subjecting one or more natural wood veneers to one or more chemical treatments, so as to form one or more lignin-compromised wood veneers;
(b) after (a), compressing the one or more lignin-compromised wood veneers along a direction crossing a longitudinal growth direction of the wood, so as to form one or more densified, lignin-compromised wood veneers; and
(c) after (b), wrapping the one or more densified, lignin-compromised wood veneers around a central axis, so as to form a circumferentially-extending wood wall.

58. The method of claim 57, further comprising, after (b) and prior to (c), providing a glue on one or more surface portions of each wood veneer.

59-66. (canceled)

67. The method of claim 57, wherein the wrapping of (c) comprises:
(c1) disposing the one or more densified, lignin-compromised wood veneers over a mold; and
(c2) after a first time, removing the mold from the one or more densified, lignin-compromised wood veneers, such that at least a portion of the circumferentially-extending wood wall is hollow.

68-71. (canceled)

72. The method of claim 57, wherein the subjecting of (a) comprises:
(a1) infiltrating the one or more natural wood veneers with one or more chemical solutions; and
(a2) after (a1), subjecting the one or more natural wood veneers with one or more chemical solutions therein to a first temperature of at least 80° C. for a first time, so as to form the one or more lignin-compromised wood veneers,
wherein, after (c), lignin retained in the one or more lignin-compromised wood veneers has shorter macromolecular chains than that of native lignin in the one or more natural wood veneers prior to (a).

73-79. (canceled)

80. The method of claim 72, wherein the subjecting to the first temperature of (a2) comprises using steam to heat the one or more natural wood veneers with the one or more chemical solutions therein.

81-92. (canceled)

93. The method of claim 57, wherein:
during (c), the one or more densified, lignin-compromised wood veneers have a water content in a range of 30-40 wt %, and
the method further comprises, after (c), drying the one or more densified, lignin-compromised wood veneers to have a water content less than or equal to 15 wt %.

94-96. (canceled)

97. The method of claim 57, further comprising, prior to (a), cutting a substantially-cylindrical portion of natural wood using a roll-cutting technique to form the one or more natural wood veneers.

98-100. (canceled)
